(19) United States
(12) Patent Application Publication
(10) Pub. No.: US 2025/0203457 A1
(43) Pub. Date: Jun. 19, 2025

(54) COMMUNICATION METHOD

(71) Applicant: KYOCERA Corporation, Kyoto (JP)

(72) Inventors: Mitsutaka HATA, Yokohama-shi, (JP); Masato FUJISHIRO, Yokohama-shi, (JP)

(73) Assignee: KYOCERA Corporation, Kyoto (JP)

(21) Appl. No.: 19/067,155

(22) Filed: Feb. 28, 2025

Related U.S. Application Data
(63) Continuation of application No. PCT/JP2023/032057, filed on Sep. 1, 2023.

(30) Foreign Application Priority Data
Sep. 2, 2022 (JP) 2022-139680

(51) Int. Cl. H04W 28/06; H04W 24/02

(52) U.S. Cl. CPC H04W 28/06; H04W 24/02

(57) ABSTRACT

In an aspect, a communication method is a communication method in a mobile communication system. The communication method includes deriving, by a data transmission entity, a trained model for a predetermined block based on a signal received from a data reception entity. The communication method includes calculating, by the data transmission entity, output data corresponding to input data by using one of the predetermined block or the trained model. The communication method includes performing, by the data transmission entity, predetermined processing when a likelihood of the input data and/or a likelihood of the output data is equal to or less than a threshold value.

### RELATED APPLICATIONS

The present application is a continuation based on PCT Application No. PCT/JP2023/032057, filed on Sep. 1, 2023, which claims the benefit of Japanese Patent Application No. 2022-139680 filed on Sep. 2, 2022. The content of which is incorporated by reference herein in their entirety.

### TECHNICAL FIELD

The present disclosure relates to a communication method.

### BACKGROUND

In recent years, in the Third Generation Partnership Project (3GPP) (trade name), which is a standardization project for mobile communication systems, a study is underway to apply an Artificial Intelligence (AI) technology, particularly, a Machine Learning (ML) technology to wireless communication (air interface) in a mobile communication system.

### CITATION LIST

### Non-Patent Literature

Non-Patent Document 1: 3GPP Contribution RP-213599, “New SI: Study on Artificial Intelligence (AI)/Machine Learning (ML) for NR Air Interface”

### SUMMARY

In an aspect, a communication method is a communication method in a mobile communication system. The communication method includes deriving, by a data transmission entity, a trained model for a predetermined block based on a signal received from a data reception entity. The communication method includes calculating, by the data transmission entity, output data corresponding to input data by using one of the predetermined block or the trained model. The communication method includes performing, by the data transmission entity, predetermined processing when a likelihood of the input data and/or a likelihood of the output data is equal to or less than a threshold value.

In an aspect, a communication method is a communication method in a mobile communication system. The communication method includes deriving, by a data transmission entity, a trained model for a predetermined block based on a signal received from a data reception entity. The communication method includes calculating, by the data transmission entity, output data corresponding to input data by using one of the predetermined block or the trained model. The communication method includes transmitting, by the data transmission entity, the input data and the output data to the data reception entity. The communication method includes calculating, by the data reception entity, a likelihood of the input data and/or a likelihood of the output data.

In an aspect, a communication method is a communication method in a mobile communication system. The communication method includes deriving, by a first user equipment, a trained model for a predetermined block based on a signal received from a base station. The communication method includes calculating, by the first user equipment, output data corresponding to input data by using the predetermined block and/or the trained model. The communication method includes calculating, by the first user equipment, a likelihood of the input data and/or a likelihood of the output data. The communication method includes associating, by the first user equipment, the input data and/or the output data with the likelihoods or likelihood and transmitting, by the first user equipment, the input data and/or the output data and the likelihoods or the likelihood to the base station. The communication method includes transmitting, by the base station, the input data and/or the output data and the likelihoods or likelihood to a second user equipment. The communication method includes determining, by the second user equipment, whether to use the input data and/or the output data as training data based on the likelihoods or likelihood.

In an aspect, a communication method is a communication method for a user equipment configured to generate a measurement report by using a measurement reporting model. The communication method includes calculating, by the user equipment, a likelihood of input data input to a predetermined block included in a measurement model and a likelihood of first output data output from the predetermined block. The communication method includes discarding, by the user equipment, the input data and/or the first output data when the likelihood of the input data and/or the likelihood of the first output data is equal to or less than a first threshold value.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a base station (gNB) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7A to FIG. 7C are diagrams each of which illustrates a configuration example of a mobile communication system according to the first embodiment.

FIG. 8 is a diagram illustrating a configuration example of a data transmission entity and a data reception entity according to the first embodiment.

FIG. 9 is a diagram illustrating a configuration example for a first operation scenario according to the first embodiment.

FIG. 10 is a diagram illustrating an operation example of the first operation scenario according to the first embodiment.

FIG. 11 is a diagram illustrating a configuration example for a second operation scenario according to the first embodiment.

FIG. 12 is a diagram illustrating a configuration example for a third operation scenario according to the first embodiment.

FIG. 13 is a diagram illustrating an operation example of the third operation scenario according to the first embodiment.

FIG. 14 is a diagram illustrating a configuration example for the third operation scenario according to the first embodiment.

FIG. 15 is a diagram illustrating a configuration example for a fourth operation scenario according to the first embodiment.

FIG. 16 is a diagram illustrating a configuration example for a measurement reporting model according to the first embodiment.

FIG. 17 is a diagram illustrating an operation example of the fourth operation scenario according to the first embodiment.

FIG. 18 is a diagram illustrating an operation example according to a second embodiment.

FIG. 19 is a diagram illustrating a configuration example according to a third embodiment.

FIG. 20 is a diagram illustrating an operation example according to the third embodiment.

FIG. 21 is a diagram illustrating an operation example according to a fourth embodiment.

FIG. 22 is a diagram illustrating an operation example according to a fifth embodiment.

FIG. 23 is a diagram illustrating a configuration example of a mobile communication system including a dedicated center.

### DESCRIPTION OF EMBODIMENTS

In a machine learning technology, when machine learning is performed by using unique data, the learning accuracy is lower than that when machine learning is performed by using appropriate data. In a mobile communication system, when processing is performed by using the unique data, inappropriate processing may be performed in some cases.

Accordingly, the present disclosure provides a communication method that enables the improvement of learning accuracy in the machine learning in the mobile communication system. The present disclosure provides a communication method that enables appropriate processing to be performed in the mobile communication system.

### First Embodiment

A mobile communication system according to a first embodiment will be described with reference to the drawings. In the description of the drawings, the same or similar parts are denoted by the same or similar reference signs.

### Configuration of Mobile Communication System

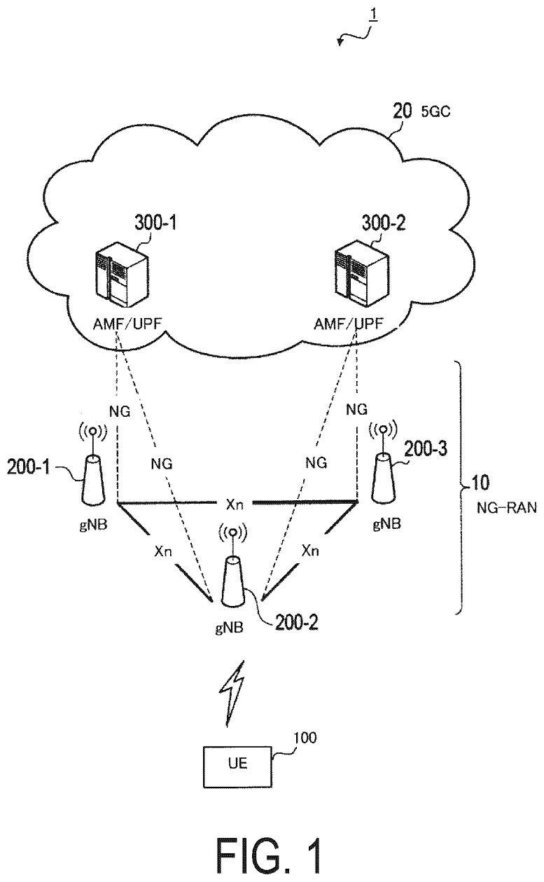

A configuration of a mobile communication system according to a first embodiment will be described. FIG. 1 is a diagram illustrating a configuration example of a mobile communication system 1 according to the first embodiment. The mobile communication system 1 complies with the 5th Generation System (5GS) of the 3GPP standard. The description below takes the 5GS as an example, but a Long Term Evolution (LTE) system may be at least partially applied to the mobile communication system. A system of the sixth (6G) or subsequent generation system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

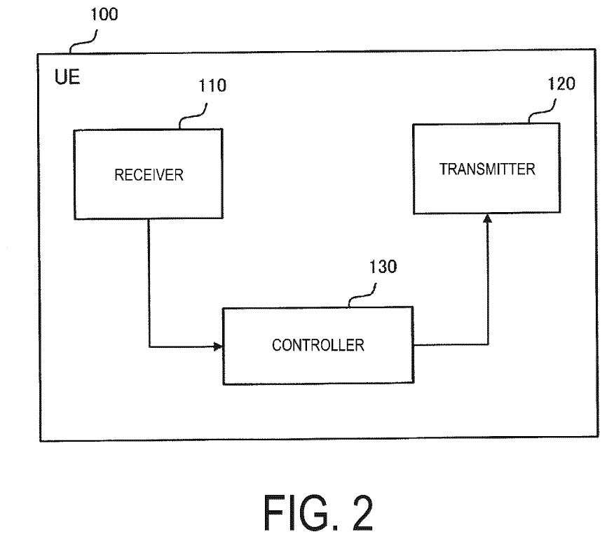

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

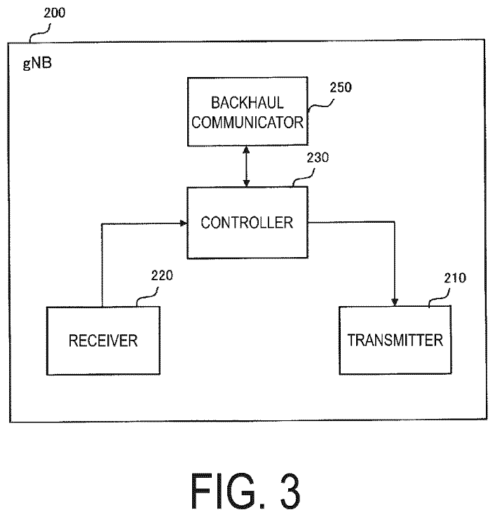

FIG. 3 is a diagram illustrating a configuration example of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

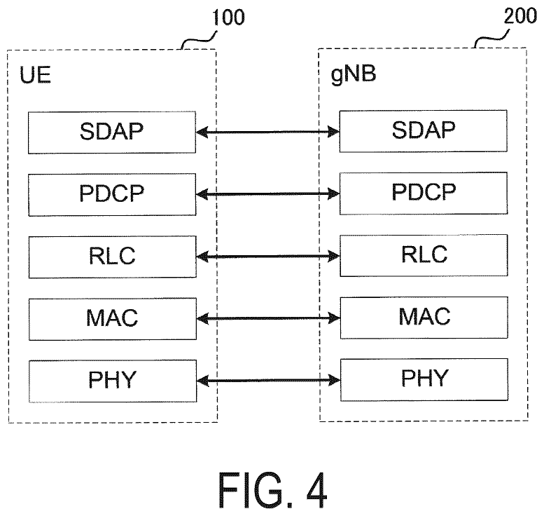

FIG. 4 is a diagram illustrating a configuration example of a protocol stack of a radio interface of a user plane handling data.

A radio interface protocol of the user plane includes a physical (PHY) layer, a medium access control (MAC) layer, a radio link control (RLC) layer, a packet data convergence protocol (PDCP) layer, and a service data adaptation protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

In the NR, the UE 100 can use a bandwidth that is narrower than a system bandwidth (i.e., a bandwidth of the cell). The gNB 200 configures a bandwidth part (BWP) consisting of consecutive physical resource blocks (PRBs) for the UE 100. The UE 100 transmits and receives data and control signals in an active BWP. For example, up to four BWPs may be configurable for the UE 100. Each BWP may have a different subcarrier spacing. Frequencies corresponding to the BWPs may overlap with each other. When a plurality of BWPs is configured for the UE 100, the gNB 200 can designate which BWP to apply by control in the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on the serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that when the RAN is connected to the EPC, the SDAP need not be provided.

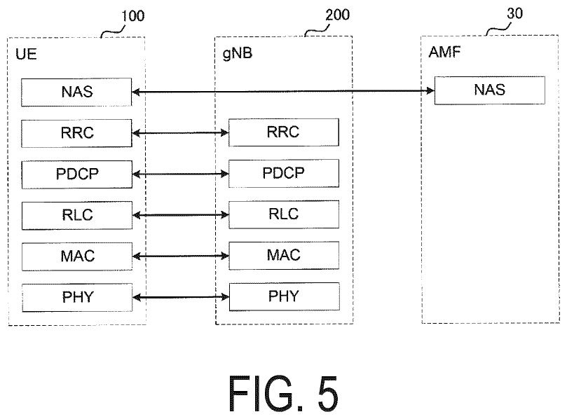

FIG. 5 is a diagram illustrating a configuration of a protocol stack of a radio interface of a control plane handling signaling (a control signal).

The protocol stack of the radio interface of the control plane includes a radio resource control (RRC) layer and a non-access stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as Access Stratum (AS).

### AI/ML Technology

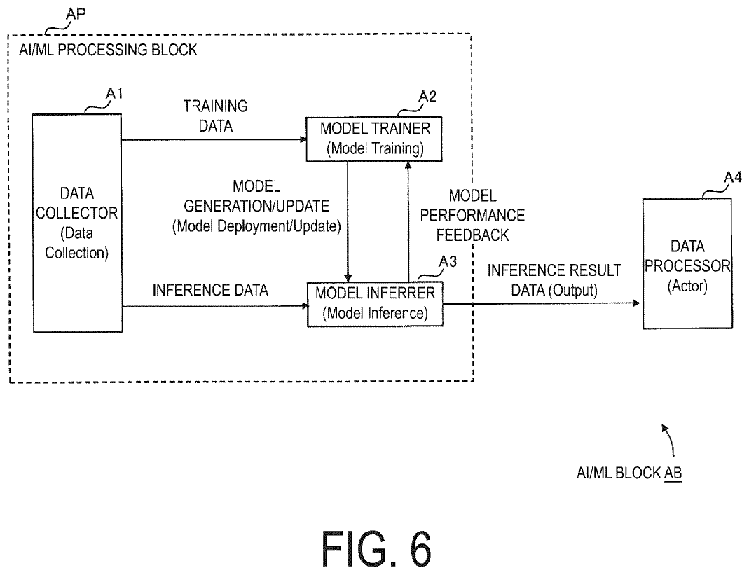

In the embodiment, an AI/ML Technology will be described. FIG. 6 is a diagram illustrating a configuration example of functional blocks of the AI/ML technology in the mobile communication system 1 according to the first embodiment. Hereinafter, the functional block of the AI/ML technology may be referred to as an AI/ML block. FIG. 6 illustrates a configuration example of the AI/ML block AB.

The AI/ML block AB illustrated in FIG. 6 includes a data collector A1, a model trainer A2, a model inferrer A3, and a data processor A4.

The data collector A1 collects input data, specifically, training data and inference data. The data collector A1 outputs the training data to the model trainer A2. The data collector A1 also outputs the inference data to the model inferrer A3. The data collector A1 may acquire, as the input data, data in an apparatus provided with the data collector A1 itself. The data collector A1 may acquire, as the input data, data in another apparatus.

The model trainer A2 performs model training. To be specific, the model trainer A2 optimizes parameters for the training model by machine learning using the training data, and derives (generates or updates) a trained model. The model trainer A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and

reinforcement learning. Supervised learning is a method of using correct answer data for the training data. Unsupervised learning is a method of not using correct answer data for the training data. For example, in unsupervised learning, feature points are trained from a large amount of training data, and correct answer determination (range estimation) is performed. Reinforcement learning is a method of assigning a score to an output result and learning a method of maximizing the score. Although supervised learning will be described below, unsupervised learning may be applied, or reinforcement learning may be applied, as the machine learning.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. Here, various approaches for the model are used, such as linear regression analysis, neural network, and decision tree analysis. The above “y=ax+b” can be considered as a type of linear regression analysis. The model inferrer A3 may perform model performance feedback to the model trainer A2.

The data processor A4 receives the inference result data and performs processing using the inference result data.

Note that a block including the data collector A1, the model trainer A2, and the model inferrer A3 may be referred to as an AI/ML processing block AP. The AI/ML processing block AP derives a trained model from the training data and outputs inference result data from the inference data by using the derived trained model.

### Applied Example of First Embodiment

An example will be described in which a machine learning technology is applied to the mobile communication system 1.

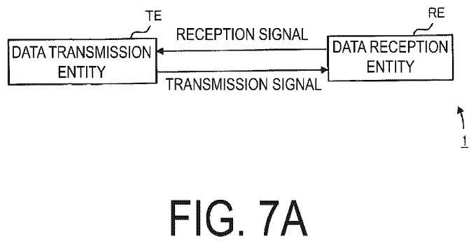

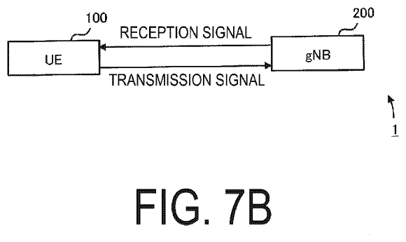

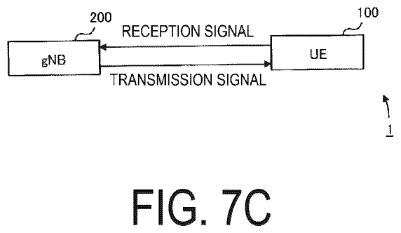

FIG. 7A is a diagram illustrating a configuration example of the mobile communication system 1 according to the first embodiment.

As illustrated in FIG. 7A, the mobile communication system 1 includes a data transmission entity TE and a data reception entity RE. An entity is, for example, a device, a functional block included in a device, or a hardware block included in a device.

The data transmission entity TE is, for example, an entity in which machine learning is performed. The data transmission entity TE derives a trained model by performing machine learning based on a reception signal received from the data reception entity RE. Then, the data transmission entity TE uses the trained model to generate inference result data as an inference result. The data transmission entity TE transmits a transmission signal including the inference result data to the data reception entity RE.

The data reception entity RE is, for example, an entity in which no machine learning is performed. The data reception entity RE receives the inference result data from the data transmission entity, and performs various processing by using the received inference result data.

FIG. 7B and FIG. 7C are diagrams each of which illustrates a configuration example of the mobile communication system 1 according to the first embodiment. As illustrated in FIG. 7B, the data transmission entity TE may be the UE 100 and the data reception entity RE may be the gNB 200. As illustrated in FIG. 7C, the data transmission entity TE may be the gNB 200 and the data reception entity RE may be the UE 100.

As described above, when the machine learning technology is applied to the mobile communication system 1, the machine learning may be performed in the UE 100 and/or the machine learning may be performed in the gNB 200. In the following description, in order to distinguish the entity in which the machine learning is performed without distinguishing between the UE 100 and the gNB 200, the data transmission entity TE and the data reception entity RE may be used for description.

Configuration Example of Data Transmission Entity and Data Reception Entity Configuration examples of the entities TE and RE will be described.

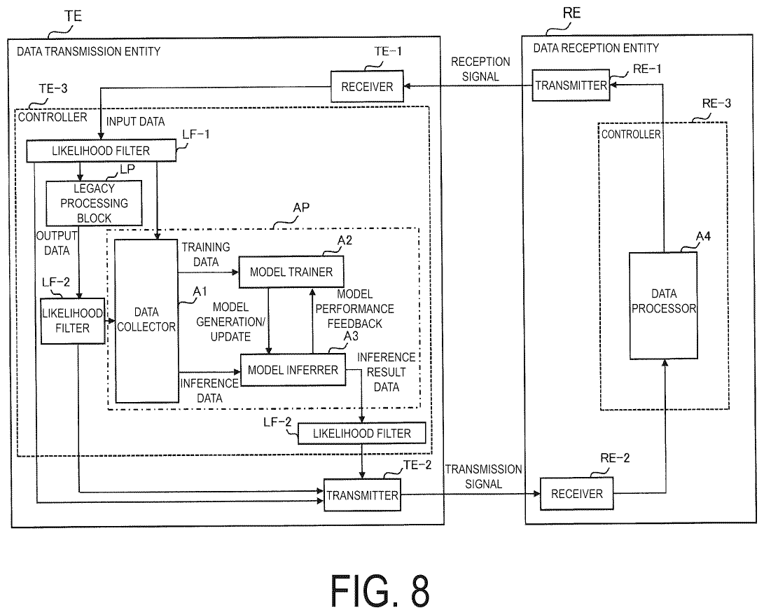

FIG. 8 is a diagram illustrating a configuration example of the data transmission entity TE and the data reception entity RE according to the first embodiment.

As illustrated in FIG. 8, the data transmission entity TE includes a receiver TE-1, a transmitter TE-2, and a controller TE-3.

The receiver TE-1 receives a signal (reception signal) transmitted from the data reception entity RE. The receiver TE-1 extracts reception data from the reception signal and outputs the extracted reception data to the controller TE-3. The receiver TE-1 corresponds to, for example, the receiver 110 in the UE 100. The receiver TE-1 corresponds to, for example, the receiver 220 in the gNB 200.

The transmitter TE-2 receives input data and output data from the controller TE-3 and generates a transmission signal including the input data and the output data. The transmitter TE-2 transmits the generated transmission signal to the data reception entity RE. The transmitter TE-2 may transmit the input data and the output data while the input data and the output data are included individually in different transmission signals instead of one transmission signal.

The controller TE-3 controls the data transmission entity TE. The controller TE-3 corresponds to, for example, the controller 130 in the UE 100 or the controller 230 in the gNB 200.

The controller TE-3 includes the AI/ML processing block AP. The machine learning is performed in the AI/ML processing block AP.

The controller TE-3 includes a legacy processing block LP. The legacy processing block LP is, for example, a block that is a target of the trained model derived in the AI/ML processing block AP. The AI/ML processing block AP derives the trained model targeted for the legacy processing block LP. The legacy processing block LP is a different block depending on an operation scenario to which the machine learning is applied in the mobile communication system 1. For example, in an operation scenario using positioning accuracy enhancement, the legacy processing block LP is a position information generator. For example, in an operation scenario using beam management, the legacy processing block LP is an optimum beam determiner. For example, in an operation scenario using Channel State Information (CSI) feedback (CSI feedback enhancement), the legacy processing block LP is a CSI generator. Note that although the legacy processing block LP is included in the controller TE-3 in the example illustrated in FIG. 8, the legacy processing block LP may be provided outside the controller TE-3.

The controller TE-3 includes a likelihood filter LF-1 for input data and a likelihood filter LF-2 for output data.

The likelihood filter LF-1 for input data is provided before the legacy processing block LP and the AI/ML processing block AP, that is, between the receiver TE-1, and the legacy processing block LP and the AI/ML processing block AP. The likelihood filter LF-1 for input data calculates a likelihood of the input data. Then, the likelihood filter LF-1 for input data performs predetermined processing when the likelihood is equal to or less than a threshold value (for example, a first threshold value or a second threshold value). Examples of the predetermined processing include processing of discarding the input data, processing of associating information indicating that the likelihood is equal to or less than the threshold value with the input data, and processing of associating the likelihood with the input data. The likelihood filter LF-1 for input data outputs the input data having the likelihood larger than the threshold value to the legacy processing block LP and the AI/ML processing block AP.

The likelihood filter LF-2 for output data is provided after the legacy processing block LP and the AI/ML processing block AP, that is, between the transmitter TE-2, and the legacy processing block LP and the AI/ML processing block AP. The likelihood filter LF-2 for output data calculates a likelihood of the output data of the legacy processing block LP. When the likelihood of the output data from the legacy processing block LP is equal to or less than a threshold value (for example, a first threshold value), the likelihood filter LF-2 for output data performs predetermined processing. Examples of the predetermined processing include processing of discarding the output data, processing of associating information indicating that the likelihood is equal to or less than the threshold value with the output data, and processing of associating the likelihood with the output data. The likelihood filter LF-2 for output data calculates the likelihood of the output data (that is, inference result data) from the AI/ML processing block AP. Then, the likelihood filter LF-2 for output data performs predetermined processing when the likelihood of the output data from the AI/ML processing block AP is equal to or less than a threshold value (for example, a second threshold value). Examples of the predetermined processing include processing of discarding the output data and processing of associating information indicating that the likelihood is equal to or less than the threshold value with the output data.

In FIG. 8, the likelihood filter LF-2 for output data is illustrated by using two blocks in the drawing, but may be constituted by one block.

Note that the input data is data input to the legacy processing block LP and the AI/ML processing block AP. The input data is also inference data input to the model inferrer A3 of the AI/ML processing block AP. The input data may be training data input to the model trainer A2 of the AI/ML processing block AP. Specific examples of the input data are different from each other depending on operation scenarios. The specific examples of the input data will be described as appropriate in description of the respective operation scenarios.

The output data is data output from each of the legacy processing block LP and the AL/ML processing block AP. The output data is also inference result data output from the model inferrer A3 of the AI/ML processing block AP. Specific examples of the output data are also different from each other depending on the operation scenarios. Specific examples of the output data will also be described as appropriate in the description of the respective operation scenarios.

The likelihood is, for example, an index representing a plausibility. The higher the likelihood is, the higher the plausibility of the data is, and the lower the likelihood is, the lower the plausibility of the data is.

The data reception entity RE includes a transmitter RE-1, a receiver RE-2, and a controller RE-3.

The transmitter RE-1 transmits a signal (reception signal) to the data transmission entity TE. The transmitter RE-1 corresponds to, for example, the transmitter 120 in the UE 100 or the transmitter 210 in the gNB 200.

The receiver RE-2 receives a signal (transmission signal) transmitted from the data transmission entity TE. The receiver RE-2 extracts data and the like from the signal and outputs the extracted data and the like to the controller RE-3. The receiver RE-2 corresponds to, for example, the receiver 110 in the UE 100 or the receiver 220 in the gNB 200.

The controller RE-3 controls the data reception entity RE. The controller RE-3 corresponds to, for example, the controller 130 in the UE 100 or the controller 230 in the gNB 200. The controller RE-3 includes the data processor A4 of the AI/ML block AB.

As described above, in the first embodiment, the likelihood filters LF-1 and LF-2 in the data transmission entity TE can discard input data and/or output data having a likelihood equal to or less than a threshold value.

Specifically, first, a data transmission entity (for example, the data transmission entity TE) derives a trained model for a predetermined block (for example, the legacy processing block) based on a signal (for example, a reception signal) received from a data reception entity (for example, the data reception entity RE). Second, the data transmission entity calculates the output data corresponding to the input data by using one of the predetermined block or the trained model. Third, the data transmission entity performs predetermined processing when the likelihood of the input data and/or the likelihood of the output data is equal to or less than a threshold value. The predetermined processing is one of processing of in which the data transmission entity discards the input data and/or the output data, processing in which the data transmission entity associates the input data and/or the output data with information indicating that the likelihood of the input data and/or the likelihood of the output data is equal to or less than the threshold value, or processing in which the data transmission entity associates the input data and/or the output data with the likelihoods or likelihood.

Accordingly, for example, when the output data corresponding to the input data is calculated by using a trained block, the input data and/or the output data having the likelihood equal to or less than the threshold value is discarded. Thus, the AI/ML processing block AP can perform machine learning by using appropriate data without using unique data. As a result, in the first embodiment, the learning accuracy can be improved, compared with that when machine learning is performed by using unique data.

For example, the data transmission entity TE can also discard the input data and/or the output data having a likelihood equal to or less than a threshold value. Thus, the data transmission entity TE does not transmit unique data having the likelihood equal to or less than the threshold value to the data reception entity RE. Thus, since the data reception entity RE does not perform processing by using the unique data, the data reception entity RE can perform processing more appropriately than that when processing is performed by using the unique data.

Even when the data reception entity RE receives the input data and/or the output data from the data transmission entity TE while information indicating that the likelihood of the input data and/or the likelihood of the output data is equal to or less than the threshold value is associated, the input data and/or the output data can be discarded because of the association of the information. When the likelihoods or likelihood is associated with the input data and/or the output data, the data reception entity RE may discard the input data and/or the output data based on the likelihoods or likelihood. Thus, since the data reception entity RE can perform processing without using unique data having a likelihood equal to or less than a threshold value, appropriate processing can be performed, compared to when processing is performed by using unique data.

Note that the example in which the likelihood filter LF-1 for input data and the likelihood filter LF-2 for output data are used as the likelihood filter has been described with reference to FIG. 8, but the present disclosure is not limited thereto. For example, one of the likelihood filter LF-1 for input data or the likelihood filter LF-2 for output data may be included in the data transmission entity TE. This is because the input data or the output data having the likelihood equal to or less than the threshold value is discarded by any one of the likelihood filters, resulting in the improvement of the learning accuracy and the appropriate performance of processing in the data reception entity RE, compared with when unique data is included in both the input data and the output data.

### Filtering Method of Likelihood Filter

A filtering method of the likelihood filters LF-1 and LF-2 will be described.

The filtering method using the likelihoods used in the likelihood filters LF-1 and LF-2 may use a known method in making a determination. For example, the determination may be made as follows. In any case, the likelihood filters LF-1 and LF-2 perform predetermined processing when the likelihood is equal to or less than the threshold value, and output the input data as it is when the likelihood is larger than the threshold value.

That is, the determination may be made based on whether a difference between data input to the likelihood filters LF-1 and LF-2 and data input immediately before the data is equal to or less than a threshold value.

The likelihood filters LF-1 and LF-2 may calculate an average value and a deviation of the input data and determine whether the deviation of the input data is equal to or less than a

The likelihood filters LF-1 and LF-2 may calculate a Euclidean distance for each of pieces of input data and make a determination based on whether the Euclidean distance is equal to or less than a threshold value.

The likelihood filters LF-1 and LF-2 may calculate a vector corresponding to the input data and determine whether a direction and a magnitude of the vector are equal to or less than threshold values.

The likelihood filter LF-1 and/or the likelihood filter LF-2 may obtain data after filtering of input data by machine learning as unsupervised learning.

The likelihood filters LF-1 and LF-2 may calculate the likelihood of the input data by using a known calculation formula such as a probability density function and determine whether the calculated likelihood is equal to or less than a threshold value.

Hereinafter, a technique using a calculation formula will be mainly described, but the present disclosure is not limited thereto, as described above.

Note that the threshold values used in filtering by the likelihood filters LF-1 and LF-2 may be the same or different between the likelihood filter LF-1 for input data and the likelihood filter LF-2 for output data. In the following description, the threshold values used in the likelihood filters LF-1 and LF-2 are assumed to be the same. The threshold value may be changed according to environmental conditions of the UE 100 (for example, a movement speed of the UE 100).

In addition, the type of filter used for the likelihood filters LF-1 and LF-2, the calculation method (or calculation formula), and/or the threshold value may be indicated from the outside of the data transmission entity TE (may be the data reception entity RE).

### Operation Scenarios

Four operation scenarios will be described as specific examples in which the AI/ML block AB is applied to the mobile communication system 1. The following four operation scenarios will be described in order.
(1.1) First operation scenario: an operation scenario using positioning accuracy enhancement
(1.2) Second operation scenario: an operation scenario using beam management
(1.3) Third operation scenario: an operation scenario using Channel State Information (CSI) feedback enhancement
(1.4) Fourth operation scenario: an operation scenario using a measurement reporting model (measurement model)

### (1.1) First Operation Scenario

A first operation scenario according to the first embodiment will be described.

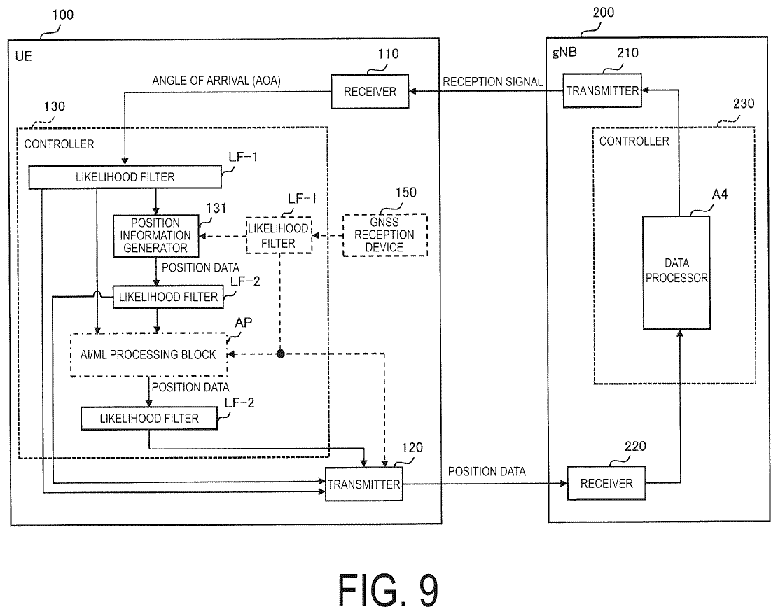

FIG. 9 is a diagram illustrating a configuration example for the first operation scenario according to the first embodiment.

In the first operation scenario, the UE 100 generates position information based on an Angle of Arrival (AoA) of a reception signal. In the first operation scenario, the UE 100 derives a trained model for the position information generator 131 in the AI/ML processing block AP based on the angle of arrival and position data, and obtains the position data (that is, inference result data) from the angle of arrival (that is, inference data) by using the trained model. In the example illustrated in FIG. 9, the position data can be calculated by calculating the position data (output data) by the position information generator 131 or calculating the position data (output data) by the AI/ML processing block AP.

In the first operation scenario illustrated in FIG. 9, the data transmission entity TE is the UE 100 and the data reception entity RE is the gNB 200. In the first operation scenario illustrated in FIG. 9, the legacy processing block LP serves as the position information generator 131. The position information generator 131 generates position information of the UE 100 from the angle of arrival (input data). The position information generator 131 outputs the generated position information as position data (output data). In the first operation scenario illustrated in FIG. 9, the input data is the angle of arrival of a reception signal and the output data is position data. Note that the position data includes position data output from the position information generator 131 and the position data (that is, inference result data) output from the AI/ML processing block AP.

As illustrated in FIG. 9, the UE 100 includes the likelihood filters LF-1 and LF-2. The likelihood filter LF-1 for input data is provided between the receiver 110 and the position information generator 131. The likelihood filter LF-1 for input data is provided between the receiver 110 and the AI/ML processing block AP. The likelihood filter LF-1 for input data calculates the likelihood of an angle of arrival (input data). The likelihood filter LF-1 performs predetermined processing such as discarding the angle of arrival when the likelihood is equal to or less than the threshold value. The likelihood filter LF-1 for input data outputs the data of the angle of arrival having the likelihood larger than the threshold value to the transmitter 120, the AI/ML processing block AP, and the position information generator 131.

The likelihood filter LF-2 for output data is provided between the position information generator 131 and the AI/ML processing block AP. The likelihood filter LF-2 for output data is provided between the AI/ML processing block AP and the transmitter 120. The likelihood filter LF-2 for output data calculates the likelihood of position data (output data) output from the position information generator 131 and the likelihood of the position data (output data) output from the AI/ML processing block AP. Then, the likelihood filter LF-2 performs predetermined processing such as discarding the position data when the likelihood is equal to or less than the threshold value. On the other hand, the likelihood filter LF-2 outputs the position data having the likelihood larger than the threshold value to the AI/ML processing block and the transmitter 120.

The transmitter 120 transmits a transmission signal to the gNB 200. The transmission signal includes the input data (data of the angle of arrival) having the likelihood larger than the threshold value and the output data (position data) having the likelihood larger than the threshold value.

Although FIG. 9 illustrates the example in which the likelihood filter LF-1 for input data and the likelihood filter LF-2 for output data are included in the UE 100, the present disclosure is not limited thereto. As described above, any of the likelihood filters LF-1 or LF-2 may be included in the UE 100.

### (1.1.1) Operation Example of First Operation Scenario

An operation example of a first operation scenario according to the first embodiment will be described.

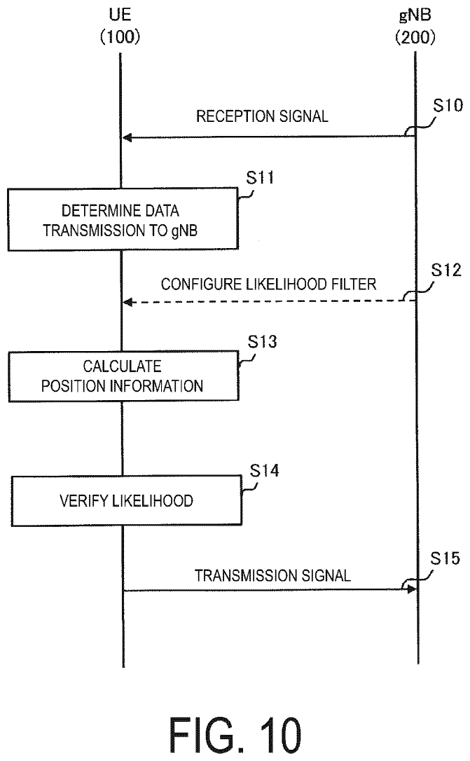

FIG. 10 is a diagram illustrating the operation example of the first operation scenario according to the first embodiment.

As illustrated in FIG. 10, in step S10, the gNB 200 transmits a signal (reception signal) to the UE 100.

In step S11, the UE 100 determines data transmission to the gNB 200. The data to be transmitted is input data and/or output data. Note that the UE 100 may receive an indication for data transmission from the gNB 200. For example, the gNB 200 may transmit, to the UE 100, a message (for example, an RRC message) including indication information representing an indication for data transmission. The UE 100 may determine the data transmission in response to receiving the indication information.

In step S12, the gNB 200 may perform configuration related to likelihoods or likelihood for the UE 100. The configuration may include the type of filter used for each of the likelihood filter LF-1 and/or the likelihood filter LF-2. Alternatively, in the configuration, an input value of input data input to each of the likelihood filter LF-1 and/or the likelihood filter LF-2 may be designated. The input value may indicate a possible range of the input data. Alternatively, in the configuration, an output value of output data output from each of the likelihood filter LF-1 and/or the likelihood filter LF-2 may be designated. The output value may indicate a possible range of the output data. Alternatively, when machine learning is used for the likelihood filter LF-1 and/or the likelihood filter LF-2, the configuration may include a proper name of a training model, an architecture type of the training model (linear regression analysis, deep neural network (DNN), or the like), and/or an application type of the training model (stationary type, movement type, or the like). The configuration may include a threshold value of the likelihoods or likelihood. The UE 100 performs predetermined processing on the input data and/or the output data based on the threshold value. The gNB 200 may transmit a message including the configuration (for example, an RRC message) and thus provide the configuration. Alternatively, the configuration may be hard-coded in advance in the UE 100.

In step S13, the UE 100 calculates position data (output data) from an angle of arrival (input data) by using the position information generator 131 or a trained model. When the trained model is used, at least the trained model for the position information generator 131 is assumed to be derived in the AI/ML processing block AP.

In step S14, the UE 100 calculates and verifies a likelihood of the input data and/or a likelihood of the output data. When the likelihood is equal to or less than the threshold value, the predetermined processing (for example, discarding) is performed on the input data and/or the output data. When the likelihood is larger than the threshold value, the input data and/or the output data is output to the transmitter 120. That is, the likelihood filter LF-1 for input data discards data of an angle of arrival having a likelihood equal to or less than the threshold value, and outputs data of an angle of arrival having a likelihood larger than the threshold value to the position information generator 131, the AI/ML processing block AP, and the transmitter 120. For example, when data of an angle of arrival larger than an assumed angle of arrival from a reception signal received by the UE 100 is input, as the input data, to the likelihood filter LF-1, the likelihood becomes equal to or less than the threshold value. The likelihood filter LF-2 for output data discards position data having a likelihood equal to or less than the threshold value and outputs position data having a likelihood larger than the threshold value to the AI/ML processing block AP and the transmitter 120. For example, when the position data indicates an improbable location (for example, when the UE 100 is present in Japan, the position data indicates New York), the likelihood may be equal to or less than the threshold value.

In step S15, the UE 100 transmits a transmission signal to the gNB 200. For example, the transmitter 120 transmits a transmission signal including data of an angle of arrival (input data) and/or position data (output data, and position data output from the position information generator 131 or position data output from the AI/ML processing block AP) having a likelihood larger than the threshold value.

### (1.1.2) Another Example in First Operation Scenario

In the first operation scenario, the angle of arrival of the reception signal in the UE 100 has been described as an example of the input data, but the input data is not limited thereto. The input data used in the first operation scenario is, for example, as follows.
A reception level of each antenna in the UE 100, a reception phase of each antenna in the UE 100, or an Observed Time Difference Of Arrival (OTDOA) of each antenna in the UE 100
Positioning information (positioning information (longitude, latitude, and altitude) acquired from a Global Navigation Satellite System (GNSS) reception signal, positioning information acquired by using DownLink Time Difference Of Arrival (DL-TDOA), or positioning information acquired by using multi-Round Trip Time (RTT))
An index representing the quality of a reception signal (Reference Signal Received Power (RSRP), Reference Signal Received Quality (RSRQ), Signal to Interference plus Noise Ratio (SINR)), an output waveform of a reception signal from an AD converter in the receiver 110, or the like
Information related to line-of sight (line-of-sight information (Line Of Sight (LOS)) and non-line-of-sight information (Non Line Of Sight (NLOS))) in the UE 100
A measurement timing of a reception signal in the UE 100
An RF fingerprint (a cell ID and a reception quality in the cell having the cell ID)
Reception information of a beacon that is used in short-range wireless communication such as a wireless Local Area Network (LAN) such as Wi-Fi (trade name), or Bluetooth (trade name)
A movement speed of the UE 100

At least two among these pieces of the input data may be used in combination as appropriate.

As illustrated in FIG. 9, the GNSS reception device 150 included in the UE 100 may calculate, based on a GNSS reception signal, positioning information as the positioning information acquired from the GNSS reception signal in the input data described above. In this case, the likelihood filter LF-1 for input data is provided between the GNSS reception device 150 and the position information generator 131, calculates a likelihood corresponding to the positioning information, performs the predetermined processing according to the threshold value, and outputs the positioning information to the position information generator 131. For the input data described above, the GNSS reception device 150 may also calculate the movement speed of the UE 100. A speed sensor in the UE 100 may obtain the movement speed of the UE 100.

### (1.2) Second Operation Scenario

A second operation scenario according to the first embodiment will be described.

The second operation scenario uses beam management. In the operation scenario using the beam management, for example, the UE 100 determines an optimal beam based on a CSI reference signal (CSI-RS) transmitted from the gNB 200.

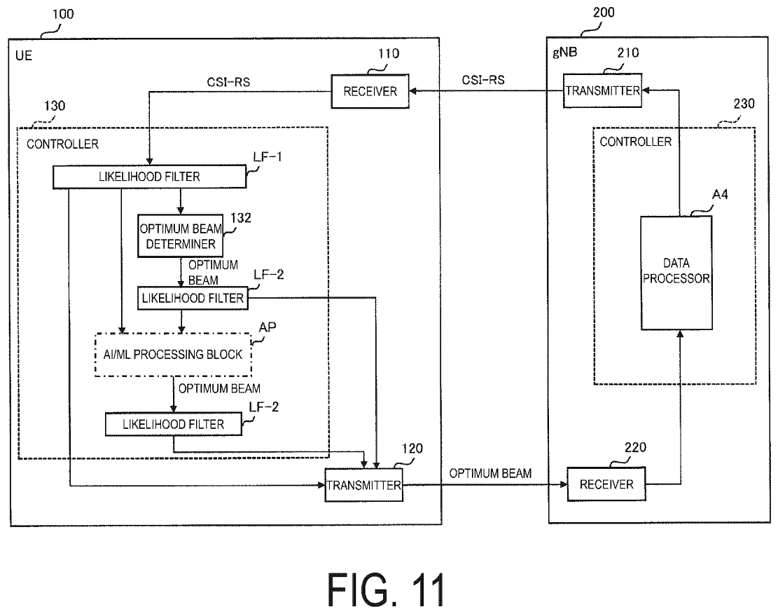

FIG. 11 is a diagram illustrating a configuration example for the second operation scenario according to the first embodiment.

As illustrated in FIG. 11, in the second operation scenario, the legacy processing block LP is an optimum beam determiner 132. The optimum beam determiner 132 determines an optimum beam from among a plurality of beams transmitted from the gNB 200 based on the CSI-RS. The AI/ML processing block AP derives a trained model for the optimum beam determiner 132 as a target block.

In the example illustrated in FIG. 11, the input data is a CSI reference signal (CSI-RS), and the output data is data representing the optimum beam. Thus, as illustrated in FIG. 11, the likelihood filter LF-1 for input data calculates a likelihood for the CSI-RS. The likelihood filter LF-1 performs predetermined processing such as discarding the CSI-RS when the likelihood is equal to or less than the threshold value. Then, the likelihood filter LF-1 outputs the CSI-RS to the optimum beam determiner 132, the AI/ML processing block AP, and the transmitter 120 when the likelihood is larger than the threshold value. The likelihood filter LF-2 for output data calculates a likelihood for data representing the optimum beam. The likelihood filter LF-2 performs predetermined processing such as discarding the data representing the optimum beam when the likelihood is equal to or less than the threshold value. The likelihood filter LF-2 outputs the data representing the optimum beam to the AI/ML processing block AP and the transmitter 120 when the likelihood is larger than the threshold value.

The transmitter 120 transmits, to the gNB 200, a transmission signal including the input data (CSI-RS) and the output data (optimum beam) each of which has the likelihood larger than the threshold value.

Note that regarding the likelihood filters LF-1 and LF-2 illustrated in FIG. 11, as in the first operation scenario, one of the likelihood filter LF-1 or the likelihood filter LF-2 may be included in the UE 100.

The operation example in the second operation scenario can also be operated as in the first operation example (FIG. 10). However, in FIG. 10, the optimum beam may be determined instead of the calculation of the position information (step S13). In this case, in the UE 100, the optimum beam determiner 132 may be used to determine the optimum beam. In the UE 100, the trained model derived in the AI/ML processing block AP may be used to determine the optimum beam.

### (1.2.1) Another Example of Second Operation Scenario

The example illustrated in FIG. 11 has been described by using the CSI-RS as the input data, but the present disclosure is not limited thereto. For example, the following may be used as the input data.
A Synchronization Signal Block (SSB) received from the gNB 200
An index representing the quality of a reception signal (RSRP, RSRQ, SINR, output waveform of the AD converter, or the like)
A Bit Error Rate (BER) in a reception signal or a BLock Error Rate (BLER) in a reception signal
The number of beams that are transmitted from the gNB 200 (beam number) or a beam pattern
A measurement value corresponding to a beam itself
A movement speed of the UE 100

At least two among these pieces of the input data may be used in combination as appropriate.

### (1.3) Third Operation Scenario

A third operation scenario according to the first embodiment will be described.

The third operation scenario uses CSI feedback. In the operation scenario using CSI feedback, for example, the UE 100 feeds back channel state information (CSI) to the gNB 200 based on the CSI-RS transmitted from the gNB 200.

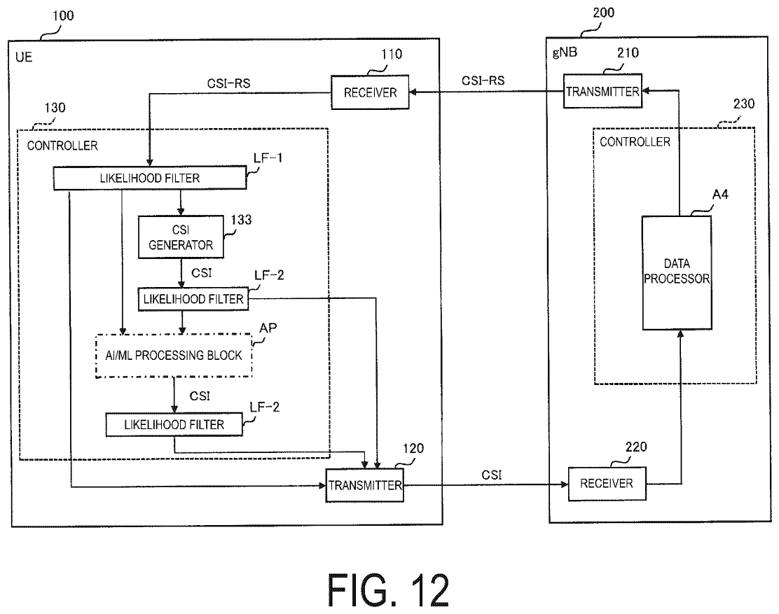

FIG. 12 is a diagram illustrating a configuration example of the third operation scenario according to the first embodiment.

As illustrated in FIG. 12, in the third operation scenario, the legacy processing block LP is the CSI generator 133. The CSI generator 133 generates, based on the CSI-RS, CSI indicating a channel state of a downlink between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI. The AI/ML processing block AP derives a trained model for the CSI generator 133 as a target block.

As illustrated in FIG. 12, the input data is the CSI-RS and the output data is the CSI. Thus, as illustrated in FIG. 12, the likelihood filter LF-1 for input data calculates a likelihood for the CSI-RS. The likelihood filter LF-1 performs predetermined processing such as discarding the CSI-RS when the likelihood is equal to or less than the threshold value. Then, the likelihood filter LF-1 outputs the CSI-RS to the optimum beam determiner 132, the AI/ML processing block AP, and the transmitter 120 when the likelihood is larger than the threshold value. The likelihood filter LF-2 for output data calculates a likelihood for the CSI. The likelihood filter LF-2 performs predetermined processing such as discarding the CSI when the likelihood is equal to or less than the threshold value. Then, the likelihood filter LF-2 outputs the CSI to the AI/ML processing block AP and the transmitter 120 when the likelihood is larger than the threshold value.

The transmitter 120 transmits, to the gNB 200, a transmission signal including the input data (CSI-RS) and the output data (CSI) each of which has the likelihood larger than the threshold value. The transmitter 120 may transmit, to the gNB 200, a transmission signal including the input data having the likelihood less than the threshold value and the output data having the likelihood less than the threshold value, and information indicating that the likelihoods are less than the threshold value. Alternatively, the transmitter 120 may transmit, to the gNB 200, a transmission signal including the input data and/or the output data associated with the likelihoods or likelihood.

Note that regarding the likelihood filters LF-1 and LF-2 illustrated in FIG. 12, as in the first operation scenario, one of the likelihood filter LF-1 or LF-2 may also be included in the UE 100.

### (1.3.1) Operation Example of Third Operation Scenario

An operation example of a third operation scenario according to the first embodiment will be described.

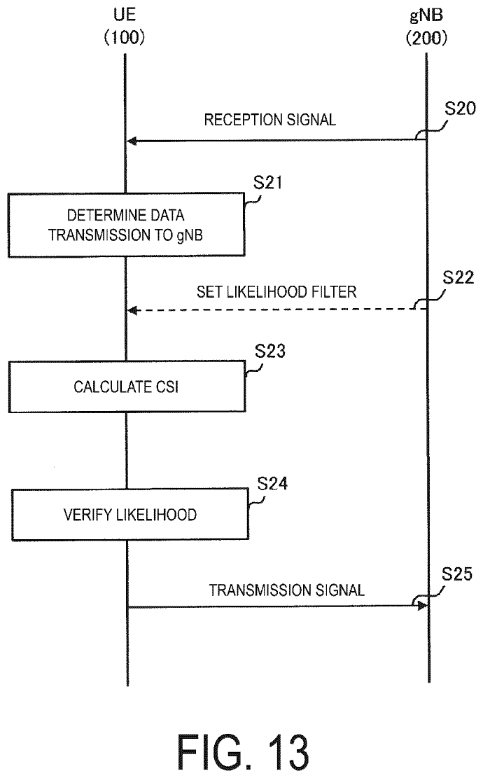

FIG. 13 is a diagram illustrating an operation example of the third operation scenario according to the first embodiment. Step S20 to step S22 are the same as step S10 to step S12 of the operation example (FIG. 10) in the first operation scenario, respectively.

In step S23, the UE 100 calculates the CSI by using one of the CSI generator 133 or the trained model. The trained model is derived for the CSI generator 133 by the AI/ML processing block AP.

In step S24, the UE 100 verifies the likelihood of the CSI-RS and/or the likelihood of the CSI. The UE 100 may discard the CSI-RS having the likelihood equal to or less than the threshold value. The UE 100 may discard the CSI having the likelihood equal to or less than the threshold value. In this case, instead of discarding the CSI-RS, the likelihood filter LF-1 may associate, with the CSI-RS, information indicating that the likelihood is equal to or less than the threshold value. Alternatively, the likelihood filter LF-1 may associate the CSI-RS with the likelihood. The likelihood filter LF-1 may output the CSI-RS and the information associated with each other to the transmitter 120. In the likelihood filter LF-1, the CSI-RS and the information associated with each other may be stored in an internal memory of the UE 100 without being output. The likelihood filter LF-2 may associate, with the CSI, information indicating that the likelihood is equal to or less than the threshold value instead of discarding the CSI. The likelihood filter LF-2 may output the CSI and the information associated with each other to the transmitter 120. Alternatively, the likelihood filter LF-2 may associate the CSI with the likelihood. The likelihood filter LF-2 may output the CSI and the likelihood associated with each other to the transmitter 120. Thus, the UE 100 may include the CSI-RS and the information associated with each other in a transmission signal and transmit the transmission signal to the gNB 200. The UE 100 may include the CSI and the information associated with each other in a transmission signal and transmit the transmission signal to the gNB 200 (step S25).

In step S25, the UE 100 transmits, to the gNB 200, the transmission signal including the CSI-RS and/or the CSI each of which has the likelihood larger than the threshold value. As described above, the UE 100 may transmit, to the gNB 200, the transmission signal including the CSI-RS having the likelihood less than the threshold value and/or the CSI having the likelihood less than the threshold value and the information indicating that the likelihoods or likelihood is less than the threshold value. Alternatively, as described above, the UE 100 may transmit, to the gNB 200, the transmission signal including the CSI-RS and/or the CSI and the likelihoods or likelihood that have been associated with each other.

### (1.3.1) Another Example of Third Operation Scenario

Although in FIG. 12, the example in which the CSI-RS is used as the input data has been described, the present disclosure is not limited to this and, for example, the following may be used as the input data.
An index representing the quality of a reception signal (RSRP, RSRQ, SINR, output waveform of the AD converter, or the like)
A Bit Error Rate (BER) in a reception signal or a BLock Error Rate (BLER) in a reception signal
A movement speed of the UE 100

At least two among these pieces of the input data may be used in combination as appropriate.

In the example illustrated in FIG. 12, the data transmission entity TE is the UE 100 and the data reception entity RE is the gNB 200, but the third operation scenario is not limited thereto. The data transmission entity TE may be the gNB 200 and the data reception entity RE may be the UE 100.

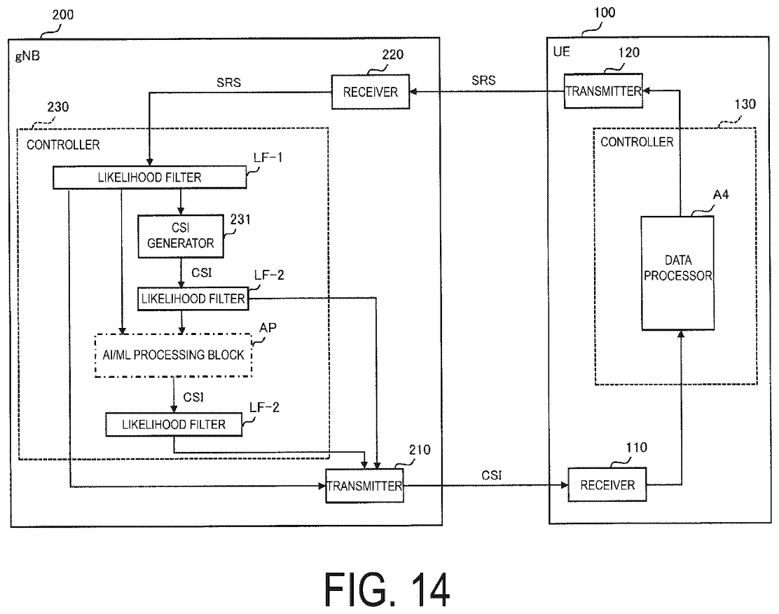

FIG. 14 is a diagram illustrating another configuration example for the third operation scenario according to the first embodiment.

As illustrated in FIG. 14, the input data is a Sounding Reference Signal (SRS) transmitted from the UE 100. The output data is the CSI and the legacy processing block LP is the CSI generator 231, as in the case illustrated in FIG. 12. The controller 230 of the gNB 200 includes the likelihood filters LF-1 and LF-2. The controller 230 may include one of the likelihood filter LF-1 or LF-2.

The operation example illustrated in FIG. 14 can be implemented by replacing the UE 100 with the gNB 200 in the operation example illustrated in FIG. 13. In this case, the gNB 200 itself may perform the configuration of the likelihood filter in step S22.

### (1.4) Fourth Operation Scenario

A fourth operation scenario according to the first embodiment will be described.

The fourth operation scenario uses a measurement reporting model (measurement model).

In the operation scenario according to the measurement reporting model, the UE 100 transmits a measurement report to the gNB 200 based on a beam formed by a signal (reception signal) transmitted from the gNB 200.

### (1.4.1) Configuration Example of Measurement Reporting Model

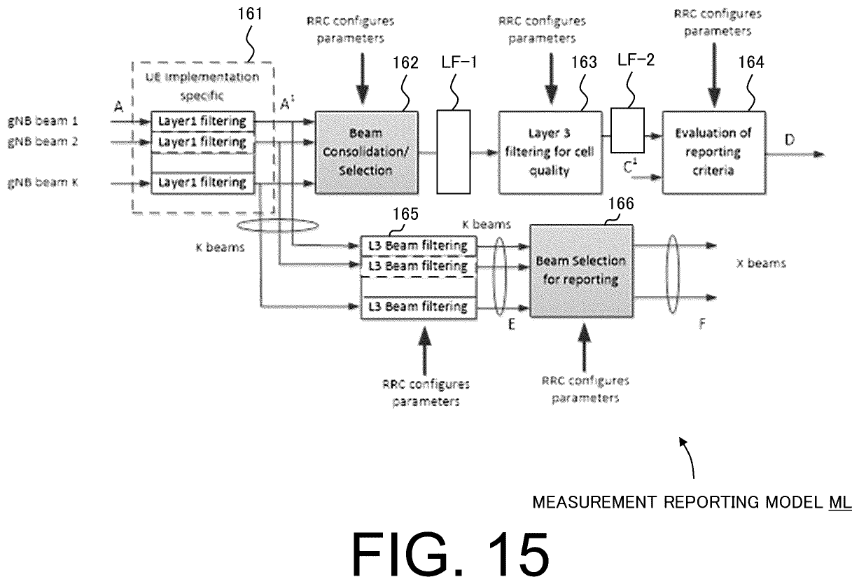

FIG. 15 is a diagram illustrating a configuration example of the fourth operation scenario according to the first embodiment.

The measurement reporting model ML illustrated in FIG. 15 is included in, for example, the controller 130 of the UE 100. However, a part of the measurement reporting model ML may be included in the receiver 220.

As illustrated in FIG. 15, the measurement reporting model ML includes a layer 1 (L1) filter (Layer 1 filtering) 161, a beam consolidation/selection unit (Beam Consolidation/Selection) 162, layer 3 (L3) filters (Layer 3 filtering for cell quality, L3 Beam filtering) 163 and 165, an evaluation unit (Evaluation of reporting criteria) 164, and a beam selection unit (Beam Selection for reporting) 166.

The L1 filter 161 receives beams (measurement values) output from antenna elements, smooths the beams, and outputs the smoothed beams to the beam consolidation/selection unit 162 and the L3 filter 165. The L1 filter 161 is implementation-dependent.

The beam consolidation/selection unit 162 consolidates the smoothed beams (measurement values) and outputs a cell quality.

The L3 filter 163 adds a hysteresis value to the cell quality and outputs the added cell quality. The hysteresis value makes it possible to avoid a phenomenon (so-called ping-pong phenomenon) in which the UE 100 performs handover a plurality of times in a short time.

The evaluation unit 164 evaluates the cell quality output from the L3 filter 163 and determines whether the cell quality is to be reported as a measurement report. The evaluation unit 164 outputs the measurement report. The measurement report is transmitted to the gNB 200 via the transmitter 120.

The L3 filter 165 adds a hysteresis value to each of the smoothed beams and outputs the added beams.

The beam selection unit 166 selects a beam (measurement value) to be reported in the measurement report from among the beams output from the L3 filter. The beam selection unit 166 includes the selected beam in the measurement report and transmits the measurement report to the gNB 200 via the transmitter 120.

Note that respective configurations of the beam consolidation/selection unit 162, the L3 filters 163 and 165, the evaluation unit 164, and the beam selection unit 166 are configured by using RRC configuration parameters.

In the first embodiment, for each of blocks included in the measurement reporting model ML configured as described above, a likelihood is calculated for each of input data input to each block and output data output from the block. When the likelihood is equal to or less than the threshold value, the input data and/or the output data is discarded.

To be more specific, firstly, a user equipment (for example, the UE 100) calculates a likelihood of input data input to a predetermined block included in a measurement reporting model (for example, the measurement reporting model ML) and a likelihood of first output data output from the predetermined block. Secondly, when the likelihood of the input data and/or the likelihood of the first output data is equal to or less than the first threshold value, the user equipment discards the input data and/or the first output data.

For example, the input data and/or the output data having the likelihood equal to or less than the first threshold value is discarded. Thus, the UE 100 or the gNB 200 can perform processing without using unique data or the like. Accordingly, the mobile communication system 1 can appropriately perform processing without unique data.

In the example illustrated in FIG. 15, the L3 filter 163 is a target block as the predetermined block. As illustrated in FIG. 15, the likelihood filter LF-1 for input data is provided before the L3 filter 163, and the likelihood filter LF-2 for output data is provided after the L3 filter. In the example illustrated in FIG. 15, the input data is a cell quality. The output data is the cell quality to which the hysteresis value is added.

Firstly, in the UE 100, the likelihoods calculated by the likelihood filters LF-1 and LF-2 may be calculated by deriving a trained model by machine learning, and then, using the derived trained model. In this case, for example, the AI/ML processing block AP may derive the trained model of the likelihood filter LF-1 with the likelihood filter LF-1 serving as the legacy processing block LP. Then, the likelihood may be obtained as the output data by using the trained model. Similarly, the AI/ML processing block AP may derive the trained model of the likelihood filter LF-2, and the likelihood may be obtained from the trained model. Alternatively, the likelihood may be calculated by a known filtering method related to the likelihood described above without using machine learning.

Secondly, the UE 100 may derive the trained model in which each block (that is, the legacy processing block LP) included in the measurement reporting model ML is a target block. The UE 100 may then use one of the block or the trained block to obtain output data corresponding to input data, and calculate likelihoods or a likelihood for the input data and/or the output data.

Specifically, firstly, the user equipment (for example, the UE 100) derives a trained model for the predetermined block based on input data (for example, data input to the L3 filter 163) and first output data (for example, data output from the L3 filter 163). Secondly, the user equipment calculates the first output data corresponding to the input data by using the predetermined block, or calculates second output data corresponding to the input data (for example, data output from the trained model of the L3 filter) by using the trained model. Thirdly, when the likelihood of the input data and/or the likelihood of the second output data is equal to or less than the second threshold value, the user equipment discards the input data and/or the second output data.

Thus, for example, a trained model is not derived by using unique data having the likelihood equal to or less than the second threshold value. This means that machine learning using an appropriate trained model can be performed, compared with when a trained model is derived by using unique data, resulting in improvement of learning accuracy.

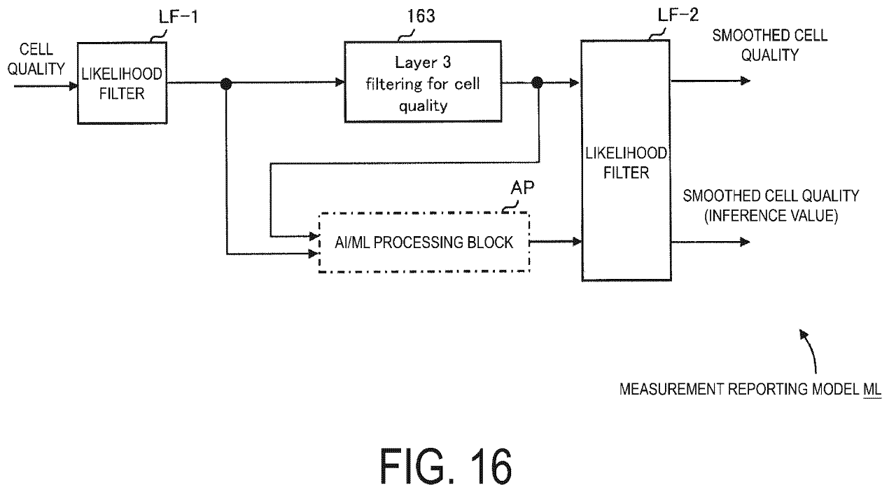

FIG. 16 is a diagram illustrating a configuration example of the measurement reporting model ML when a trained model is derived for the L3 filter 163. As illustrated in FIG. 16, the AI/ML processing block AP derives a trained model for the L3 filter 163 as a target block from the cell quality (input data) input to the L3 filter 163 and the smoothed cell quality (output data) output from the L3 filter 163.

In the measurement reporting model ML, the legacy processing block LP is each block of the measurement reporting model ML. In the example of FIG. 16, the L3 filter 163 is the legacy processing block LP. The input data is data input to each block of the measurement reporting model (or the trained model of each block). In the example of FIG. 16, the input data is the cell quality. The output data is data output from each block of the measurement reporting model (and the trained model of each block). In the example of FIG. 16, the output data is the smoothed cell quality.

In the example illustrated in FIG. 16, the likelihood filter LF-1 for input data calculates a likelihood of the cell quality (input data). Then, the likelihood filter LF-1 for input data discards the cell quality when the likelihood is equal to or less than the threshold value (for example, the first threshold value), and outputs the cell quality to the L3 filter 163 when the likelihood is larger than the threshold value. The likelihood filter LF-2 for output data calculates a likelihood of the smoothed cell quality (output data). Then, the likelihood filter LF-2 for output data discards the smoothed cell quality when the likelihood is equal to or less than the threshold value, and outputs the cell quality to the evaluation unit 164 or the transmitter 120 when the likelihood is larger than the threshold value.

As described above, since the likelihood filters LF-1 and LF-2 discard data having the likelihood equal to or less than the threshold value, the AI/ML processing block AP can derive the trained model with high learning accuracy compared with when unique data is included. This can improve the learning accuracy in the mobile communication system 1.

Note that one of the likelihood filters LF-1 and LF-2 may be included in the measurement reporting model ML, instead of both of the likelihood filters LF-1 and LF-2.

### (1.4.2) Operation Example of Fourth Operation Scenario

An operation example of a fourth operation scenario according to the first embodiment will be described.

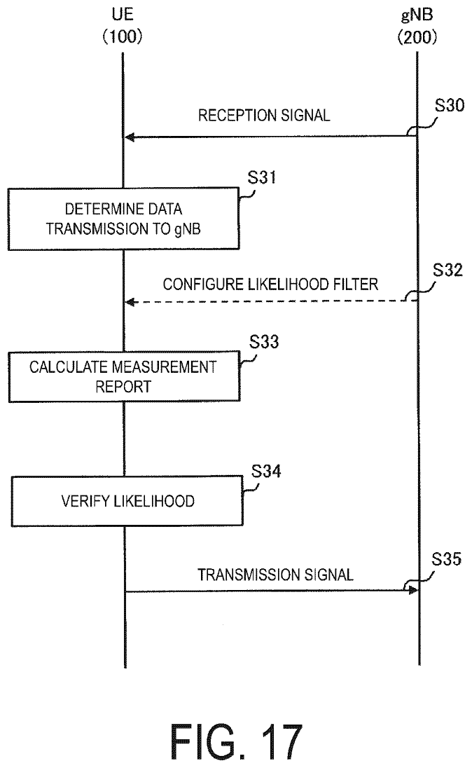

FIG. 17 is a diagram illustrating the operation example of the fourth operation scenario according to the first embodiment.

Step S30 to step S32 are the same as and/or similar to step S10 to step S12 of the operation example in the first operation scenario, respectively. However, in step S30, the gNB 200 may form a beam by using the SSB or the CSI-RS, and then transmit a transmission signal (beam). In step S32, the gNB 200 may designate an input value of each block (the L1 filter 161, the beam consolidation/selection unit 162, the L3 filters 163 and 165, the evaluation unit 164, and/or the beam selection unit 166) of the measurement reporting model ML. In step S32, the gNB 200 may designate an output value of each block of the measurement reporting model ML.

In step S33, the UE 100 calculates a measurement report. The UE 100 may calculate the measurement report by using each block of the measurement reporting model ML. The UE 100 may calculate the measurement report by using a trained model targeted for each block of the measurement reporting model ML.

In step S34, the UE 100 verifies likelihoods. For example, the UE 100 calculates and verifies the likelihoods in the likelihood filter LF-1 for input data provided before each block of the measurement reporting model ML and the likelihood filter LF-2 for output data provided after each block of the measurement reporting model ML. The likelihood filters LF-1 and LF-2 discard input data and output data having the likelihood equal to or less than the threshold value and output input data and output data having the likelihood larger than the threshold value.

In step S35, the UE 100 transmits a transmission signal. In this case, the transmission signal includes the input data and/or the output data having the likelihood larger than the threshold value, as in the first operation scenario.

### (1.4.3) Another Example of Fourth Operation Scenario

In deriving the trained model for each block of the measurement reporting model ML, data unrelated to the input data input to each block may be input to the AI/ML processing block AP. Examples of the unrelated data include position data of the UE 100 or movement speed data of the UE 100. The AI/ML processing block AP may acquire the position data or the movement speed data from the GNSS reception device 150.

### Second Embodiment

A second embodiment will be described. The second embodiment will be mainly described in terms of differences from the first embodiment.

In the second embodiment, in the data transmission entity TE, when the likelihood of the input data and/or the likelihood of the output data is equal to or less than the threshold value, the calculation of the output data is switched from the legacy processing block LP to the trained model or from the trained model to the legacy processing block LP.

Specifically, when the likelihood of the input data and/or the likelihood of the output data is equal to or less than the first threshold value while the data transmission entity (for example, the data transmission entity TE) calculates the output data by using the predetermined block (for example, the legacy processing block LP), the data transmission entity switches to the calculation of the output data by using the trained model. When the likelihood of the input data and/or the likelihood of the output data is equal to or less than the second threshold value while the data transmission entity calculates the output data by using the trained model, the data transmission entity switches to the calculation of the output data by using the predetermined block.

As described above, when the likelihood of the input data and/or the likelihood of the output data is equal to or less than the threshold value, the data transmission entity TE switches the part for calculation of the output data. This makes it possible to avoid transmission of the output data having the likelihood equal to or less than the threshold value to the data reception entity RE. Thus, the data reception entity RE can perform appropriate processing without using unique data having the likelihood equal to or less than the threshold value.

Note that whether the part for calculation before switching is set to the legacy processing block LP or the trained model may be configured as follows, for example.

Firstly, the data reception entity RE may indicate or configure the part for calculation to or for the data transmission entity TE. For example, the data reception entity RE may perform the indication or the configuration by transmitting, to the data transmission entity TE, a message (for example, an RRC message) including information (indication information or configuration information) representing whether the part for calculation of the output data is the legacy processing block LP or the trained model.

Secondly, the data transmission entity TE may select whether to use the legacy processing block LP or the trained model based on the likelihood of the input data and/or the likelihood of the output data.

Thirdly, the data transmission entity TE may select whether to use the legacy processing block LP or the trained model based on a power consumption amount. For example, the data transmission entity TE may select the part for calculation with less power consumption for the first calculation.

Fourthly, the part for the calculation before switching may be hard-coded in advance in the data transmission entity TE.

Note that the second embodiment can be applied to each of the above-described operation scenarios. For example, the operation scenario (first operation scenario) for improving the position accuracy can be implemented by using the configuration example of FIG. 9. For example, the operation scenario of beam management (second operation scenario) can be implemented by using the configuration example of FIG. 11. For example, the operation scenario of CSI feedback (third operation scenario) can be implemented by using the examples in FIG. 12 and FIG. 14. For example, the operation scenario (fourth operation scenario) of the measurement reporting model ML can be implemented by using the configuration examples of FIG. 15 and FIG. 16.

### Operation Example According to Second Embodiment

An operation example according to the second embodiment will be described.

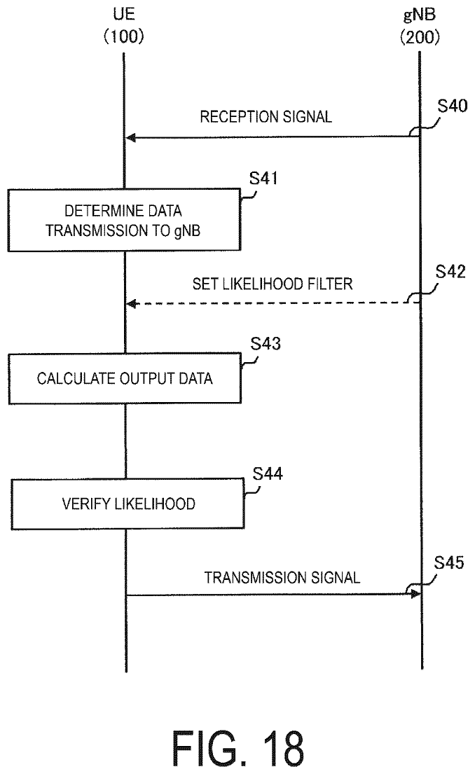

FIG. 18 is a diagram illustrating the operation example according to the second embodiment. FIG. 18 illustrates the operation example in which the data transmission entity TE is the UE 100 and the data reception entity RE is the gNB 200.

Step S40 to step S42 illustrated in FIG. 18 are the same as step S10 to step S12 of the operation example (FIG. 10) of the first operation scenario according to the first embodiment, respectively.

In step S43, the UE 100 calculates output data. The UE 100 uses one of the legacy processing block LP or the trained model and then calculates the output data. In the operation scenario for improving position accuracy (first operation scenario), the legacy processing block LP is the position information generator 131, and the output data is position data. In the beam management operation scenario (second operation scenario), the legacy processing block LP is the optimum beam determiner 132 and the output data is data representing an optimum beam. In the operation scenario using the CSI feedback (third operation scenario), the legacy processing block LP is the CSI generator 133 or 231, and the output data is CSI. In the operation scenario (fourth operation scenario) of the measurement reporting model ML, the legacy processing block LP is each block of the measurement reporting model ML, and the output data is output data of each block.

In step S44, the UE 100 verifies a likelihood of the input data and/or a likelihood of the output data. In the likelihood filter LF-1 for input data and/or the likelihood filter LF-2 for output data, the likelihood is calculated and verified. Then, when the likelihood is equal to or less than the threshold value, the UE 100 switches the part for calculation for output data. For example, when the likelihood of the input data and/or the likelihood of the output data is equal to or less than the threshold value (for example, first threshold value) in calculating the output data corresponding to the input data using the legacy processing block LP, the UE 100 switches to the calculation of the output data using the trained model. In this case, the UE 100 can switch to the calculation of the output data using the trained model by regarding the learning accuracy of the trained model to be higher than that in a case in which the learning accuracy is constant. For example, when the likelihood of the input data and/or the likelihood of the output data is equal to or less than the threshold value (for example, second threshold value) in calculating the output data corresponding to the input data using the trained model, the UE 100 switches to the calculation of the output data using the legacy processing block LP. In this case, the UE 100 can switch to the legacy processing block LP by regarding the learning accuracy of the trained model to be lower than that in a case in which the learning accuracy is constant.

When the likelihood of the input data and/or the likelihood of the output data is larger than the threshold value (first threshold value or second threshold value) in calculating the output data by using one of the legacy processing block LP or the trained model, the UE 100 continues the calculation without switching the part for calculation of the output data.

In step S45, the UE 100 transmits a transmission signal including the input data and the output data to the gNB 200.

### Another Example of Second Embodiment

In the second embodiment, the example has been described in which the UE 100 switches the part for the calculation of the output data to obtain the output data (step S45). For example, the UE 100 may calculate the output data by using both the legacy processing block LP and the trained model. In this case, the UE 100 may compare the likelihood of the output data from the legacy processing block LP and the likelihood of the output data from the trained model, and transmit the output data having the higher likelihood to the gNB 200 (step S45). Alternatively, the UE 100 may calculate the output data by using both the legacy processing block LP and the trained model, and transmit the two pieces of output data to the gNB 200. In this case, the UE 100 may calculate the likelihoods of the two pieces of output data, associate each of the calculated likelihoods with the corresponding one of the two pieces of output data, and transmit the two pieces of output data and the likelihoods to the gNB 200 (step S45).

In the second embodiment, the example has been described in which the data transmission entity TE is the UE 100 and the data reception entity RE is the gNB 200. For example, the second embodiment can also be applied to the operation scenario using the CSI feedback (third operation scenario) as described above, and can be implemented even when the gNB 200 is the data transmission entity TE and the UE 100 is the data reception entity RE (FIG. 14). In the operation example illustrated in FIG. 18, by replacing the UE 100 with the gNB 200 and replacing the gNB 200 with the UE 100, an operation example can be implemented in which the gNB 200 is the data transmission entity TE and the UE 100 is the data reception entity RE.

### Third Embodiment

A third embodiment will be described. The third embodiment will be mainly described in terms of differences from the first embodiment.

In the third embodiment, the data reception entity RE calculates a likelihood. Specifically, first, a data transmission entity (for example, the data transmission entity TE) derives a trained model for a predetermined block (for example, the legacy processing block LP) based on a signal received from a data reception entity (For example, the data reception entity RE). Second, the data transmission entity calculates the output data corresponding to the input data by using one of the predetermined block or the trained model. Third, the data transmission entity transmits the input data and the output data to the data reception entity. Fourth, the data reception entity calculates a likelihood of the input data and/or a likelihood of the output data.

Since the data reception entity RE calculates the likelihoods or likelihood as described above, the data reception entity RE can also discard the input data and the output data received from the data transmission entity TE based on the calculated likelihoods or likelihood. Thus, the data reception entity RE can process the input data and the output data without using unique data having the likelihood equal to or less than the threshold value. Accordingly, the mobile communication system 1 can appropriately perform processing.

Configuration Example According to Third Embodiment A configuration example according to the third embodiment will be described.

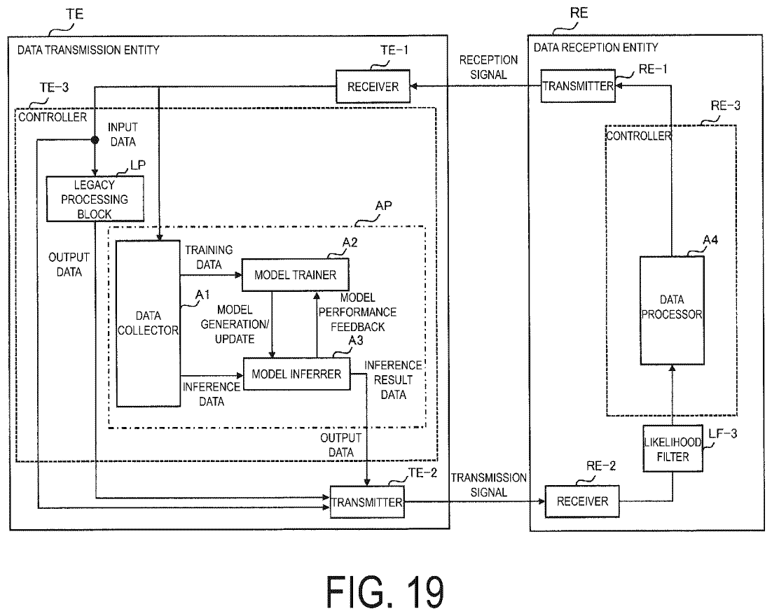

FIG. 19 is a diagram illustrating the configuration example according to the third embodiment.

As illustrated in FIG. 19, the data reception entity RE further includes a likelihood filter LF-3.

First, the likelihood filter LF-3 may calculate likelihoods of input data and output data that have been output from the receiver RE-2, and discard the input data and the output data when the likelihoods or likelihood is equal to or less than a threshold value.

Second, when the likelihoods or likelihood is equal to or less than the threshold value, the likelihood filter LF-3 may generate indication information indicating switching to calculation of the output data by using the legacy processing block LP or calculation of the output data by using a trained model. The indication information is output to the transmitter RE-1 via the controller RE-3. The transmitter RE-1 transmits a message including the indication information to the data transmission entity TE. The message may be transmitted as an RRC message. Note that when the likelihood filter LF-3 receives both the output data from the legacy processing block LP and the output data from the trained model as the output data from the data transmission entity TE, the likelihood filter LF-3 may select one of the output data from the legacy processing block LP or the output data from the trained model according to the likelihoods. The likelihood filter LF-3 may output information indicating which output data is selected to the transmitter RE-1. The transmitter RE-1 may transmit a message (for example, an RRC message) including the information to the data transmission entity TE.

Third, the likelihood filter LF-3 may output the calculated likelihoods as likelihood information to the transmitter RE-1 via the controller RE-3. The transmitter RE-1 transmits a message (for example, an RRC message) including the likelihood information to the data transmission entity TE. The data transmission entity TE may switch the part for calculation (the legacy processing block LP or the trained model) of the output data based on the likelihood information.

Note that the likelihood filter LF-3 may verify the likelihood of only one of the input data and the output data.

Each of the first to fourth operation scenarios described in the first embodiment (FIG. 9, FIG. 11, FIG. 12, FIG. 14, FIG. 15, and FIG. 16) is applicable to the third embodiment.

### Operation Example According to Third Embodiment

An operation example according to the third embodiment will be described.

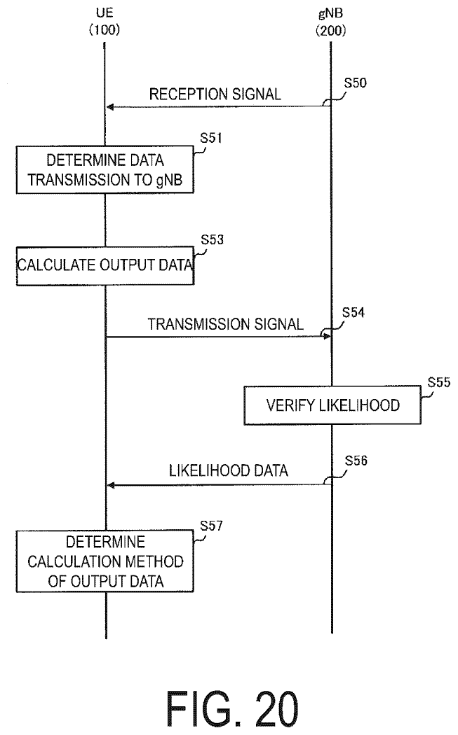

FIG. 20 is a diagram illustrating the operation example according to the third embodiment. With reference to FIG. 20, an example in which the data transmission entity TE is the UE 100 and the data reception entity RE is the gNB 200 will be described.

Step S50 and step S51 in FIG. 20 are the same as step S10 and step S11 of the operation example (FIG. 10) according to the first embodiment, respectively.

In step S53, the UE 100 calculates output data corresponding to input data by using one of the legacy processing block LP or the trained model. As in the first embodiment, the legacy processing block LP, the input data, and the output data are different corresponding to the respective applied operation scenarios.

In step S54, the UE 100 transmits a transmission signal including the input data and the output data to the gNB 200.

In step S55, the gNB 200 verifies a likelihood of the input data and/or a likelihood of the output data. The gNB 200 calculates the likelihood of the input data and/or the likelihood of the output data, and performs processing by using the input data and/or the output data when the likelihoods or likelihood is larger than the threshold value. On the other hand, when the likelihood of the input data and/or the likelihood of the output data is equal to or less than the threshold value, the gNB 200 may discard the input data and/or the output data. Alternatively, the gNB 200 may indicate the data transmission entity TE to switch the part for calculation of the output data when the likelihood of the input data and/or the likelihood of the output data is equal to or less than the threshold value. As for the switching, the gNB 200 indicates switching to the trained model when the UE 100 calculates the output data by using the legacy processing block LP. On the other hand, when the UE 100 calculates the output data by using the trained model, the gNB 200 indicates the switching to the legacy processing block LP. The gNB 200 may transmit, to the UE 100, a message (for example, an RRC message) including the indication information indicating the switching. Note that when the gNB 200 (data reception entity RE) receives both the output data from the legacy processing block LP and the output data from the trained model as the output data, the gNB 200 may select one of the output data from the legacy processing block LP and the output data from the trained model according to the likelihoods.

In step S56, when the gNB 200 calculates the likelihood of the input data and/or the likelihood of the output data, the gNB 200 may transmit the likelihoods or likelihood to the UE 100 as the likelihood information. The gNB 200 may transmit, to the UE 100, a message (for example, RRC message) including the likelihood information.

In step S57, the UE 100 may switch the part for calculation of the output data to one of the legacy processing block LP or the trained model based on the likelihood information. Regarding the switching, the UE 100 switches to the trained model when the legacy processing block LP is used to calculate the output data, and switches to the legacy processing block LP when the trained model is used to calculate the output data.

### Another Example of Third Embodiment

Also in the third embodiment, as in the second embodiment, in the operation scenario using the CSI feedback (third operation scenario), the data transmission entity TE may be the gNB 200 and the data reception entity RE may be the UE 100. This case can be implemented by replacing the UE 100 with the gNB 200 and replacing the gNB 200 with the UE 100 in the operation example illustrated in FIG. 20.

### Fourth Embodiment

A fourth embodiment will be described. The fourth embodiment will be mainly described in terms of differences from the first embodiment.

The fourth embodiment is an example in which the data reception entity RE transmits configuration information related to likelihoods or likelihood to the data transmission entity TE. Specifically, a data reception entity (for example, the data reception entity RE) transmits a message including a calculation method of the likelihoods or likelihood to a data transmission entity (for example, the data transmission entity TE).

Thereby, for example, since the data transmission entity TE can calculate the likelihoods or likelihood according to the calculation method, which has been indicated from the data reception entity RE, of the likelihoods or likelihood, the data transmission entity TE can perform processing in which data having the likelihood equal to or less than the threshold value is not transmitted to the data reception entity RE. Accordingly, the data reception entity RE does not perform processing using unique data and can perform appropriate processing.

In the fourth embodiment, first, a data reception entity (for example, the data reception entity RE) transmits a message including a minimum value of the likelihoods or likelihood to a data transmission entity (for example, the data transmission entity TE). Second, the data transmission entity transmits input data and/or output data having the likelihood equal to or larger than the minimum value to the data reception entity.

Accordingly, for example, since the data reception entity RE can receive data having the likelihood equal to or larger than the minimum value, the data reception entity RE does not receive unique data having the likelihood less than the minimum value. Thus, the data reception entity RE does not perform processing using unique data. Thus, the data reception entity RE can perform appropriate processing.

Note that each of the first to fourth operation scenarios (FIG. 9, FIG. 11, FIG. 12, FIG. 14, FIG. 15, and FIG. 16) described in the first embodiment can also be applied to the fourth embodiment.

### Operation Example According to Fourth Embodiment

An operation example according to the fourth embodiment will be described.

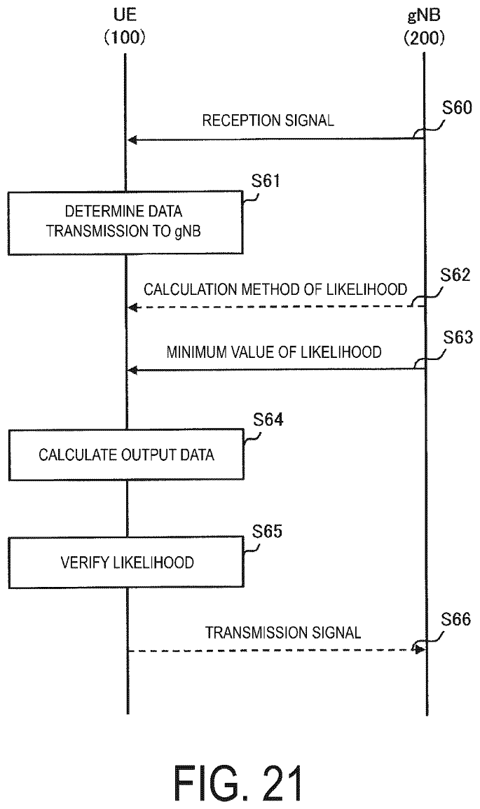

FIG. 21 is a diagram illustrating an operation example according to the fourth embodiment. In the example illustrated in FIG. 21, the UE 100 is the data transmission entity TE and the gNB 200 is the data reception entity RE.

Step S60 and step S61 in FIG. 21 are the same as step S10 and step S11 of the operation example (FIG. 10) according to the first embodiment, respectively.

In step S62, the gNB 200 transmits a calculation method of likelihoods or likelihood to the UE 100. The calculation method of the likelihoods or likelihood may be the filtering method of the likelihood filters LF-1 and LF-2 described in the first embodiment. The calculation method of the likelihoods or likelihood may indicate a calculation formula to be used in calculating the likelihoods or likelihood. The gNB 200 may transmit information indicating the calculation method to each UE 100 through dedicated signaling of an RRC message. The gNB 200 may transmit the information through broadcast signaling (for example, a System Information Block (SIB)) of an RRC message to a plurality of UEs 100.

In step S63, the gNB 200 transmits a minimum value of the likelihoods or likelihood to the UE 100. The gNB 200 may transmit the minimum value to each UE 100 through dedicated signaling of an RRC message. The gNB 200 may transmit the minimum value to the plurality of UEs 100 through broadcast signaling (for example, SIB) of an RRC message.

In step S64, the UE 100 calculates output data corresponding to input data by using one of the legacy processing block LP or the trained model. As in the first embodiment, the legacy processing block LP, the input data, and the output data are different corresponding to the respective applied operation scenarios.

In step S65, the UE 100 calculates a likelihood of the input data and/or a likelihood of the output data and verifies the likelihoods or likelihood.

In step S66, when the likelihoods or likelihood is equal to or larger than the minimum value, the UE 100 transmits a transmission signal including the input data and/or the output data having the likelihood. On the other hand, when the likelihood is less than the minimum value, the UE 100 does not transmit the input data and/or the output data having the likelihood to the gNB 200.

### Another Example According to Fourth Embodiment

Also in the fourth embodiment, the data transmission entity TE may be the gNB 200 and the data reception entity RE may be the UE 100 in the operation scenario using the CSI feedback (third operation scenario), as in the second embodiment. This case can be implemented by replacing the UE 100 with the gNB 200 and replacing the gNB 200 with the UE 100, respectively, in the operation example illustrated in FIG. 21.

### Fifth Embodiment

A fifth embodiment will be described.

In the fifth embodiment, a UE 100-1 associates input data and output data with likelihoods. A UE 100-2 determines whether to use the input data and/or the output data as training data based on the associated likelihoods.

Specifically, a first user equipment (for example, the UE 100-1) derives a trained model for a predetermined block (for example, the legacy processing block LP) based on a signal received from a base station (for example, the gNB 200). Second, the first user equipment calculates output data corresponding to input data by using the predetermined block and/or the trained model. Third, the first user equipment calculates a likelihood of the input data and/or a likelihood of the output data. Fourth, the first user equipment associates the input data and/or the output data with the likelihoods or likelihood and transmits the input data and/or the output data and the likelihoods or likelihood to the base station. Fifth, the base station transmits the input data and/or the output data and the likelihoods or likelihood to a second user equipment. Sixth, the second user equipment determines whether to use the input data and/or the output data as training data based on the likelihoods or likelihood.

Thus, for example, even the UE 100-2 that cannot calculate the likelihoods or likelihood can determine whether to use the input data and/or the output data as the training data based on the likelihoods or likelihood. Accordingly, the UE 100-2 can improve the learning accuracy by appropriately using the input data and/or the output data used in the UE 100-1 as the training data. The UE 100-2 can perform appropriate processing by not using the input data and/or the output data having the likelihood equal to or less than the threshold value.

Note that in the fifth embodiment, the UE 100-1 may associate information indicating that the likelihoods or likelihood is equal to or larger than the threshold value with the input data and/or the output data having the likelihood equal to or larger than the threshold value. Such association processing allows the UE 100-2 that has received the input data and/or the output data to determine that the input data and/or the output data is used as the training data based on the information.

In the fifth embodiment, the operation scenario in which the data transmission entity TE is the UE 100 and the data reception entity RE is the gNB 200 among the first to fourth operation scenarios described in the first embodiment can be applied (FIG. 9, FIG. 11, FIG. 12, FIG. 15, and FIG. 16).

### Operation Example According to Fifth Embodiment

An operation example according to the fifth embodiment will be described.

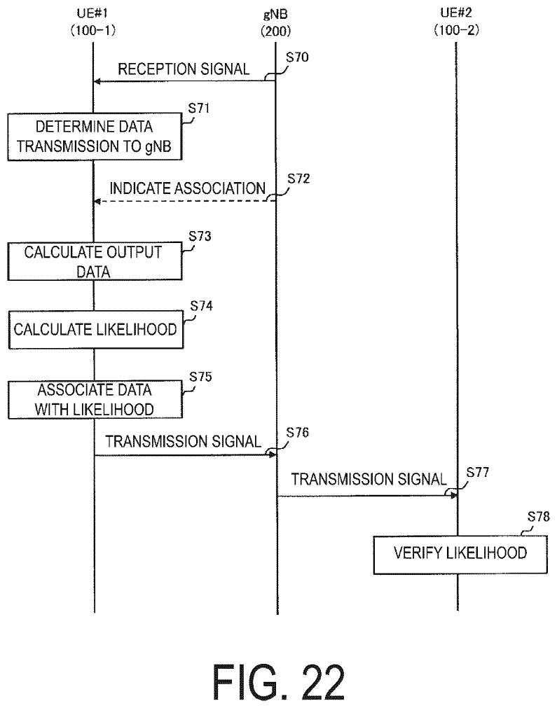

FIG. 22 is a diagram illustrating the operation example according to the fifth embodiment.

Step S70 and step S71 in FIG. 22 are the same as step S10 and step S11 of the operation example (FIG. 10) according to the first embodiment, respectively.

In step S72, the gNB 200 may transmit, to the UE 100-1, association indication information for associating the input data and the output data with the likelihoods. The association indication information may be information indicating association of information indicating that the likelihoods are equal to or larger than the threshold value with the input data and the output data having the likelihood equal to or larger than the threshold value. The gNB 200 may transmit the association indication information to each UE 100-1 through dedicated signaling of an RRC message. The gNB 200 may transmit the association indication information to a plurality of UEs 100-1 through broadcast signaling (for example, SIB) of an RRC message.

In step S73, the UE 100-1 calculates output data corresponding to input data by using one of the legacy processing block LP or the trained model. As in the first embodiment, the legacy processing block LP, the input data, and the output data are different corresponding to the respective applied operation scenarios.

In step S74, the UE 100-1 calculates a likelihood of the input data and/or a likelihood of the output data.

In step S75, the UE 100-1 associates the input data and/or the output data with the likelihoods or likelihood. The UE 100-1 may perform association in accordance with the association indication information (step S72). Alternatively, the UE 100-1 may associate the information indicating that the likelihoods or likelihood is equal to or larger than the threshold value with the input data and the output data having the likelihood equal to or larger than the threshold value. The association may be performed in accordance with the association indication information (step S72).

In step S76, the UE 100-1 transmits, to the gNB 200, a transmission signal including the input data and/or the output data and the likelihoods or likelihood that are to be associated. As in the fourth embodiment, the UE 100-1 may transmit the input data and/or the output data having the likelihood equal to or larger than a minimum value.

In step S77, the gNB 200 includes the input data and/or the output data and the likelihoods or likelihood that have been received from the UE 100-1 in a transmission signal and transmits the transmission signal to the UE 100-2.

In step S78, the UE 100-2 verifies the associated likelihoods or likelihood. When the likelihoods or likelihood are larger than the threshold value, the UE 100-2 uses the input data and/or the output data having the likelihoods or likelihood as training data. On the other hand, when the likelihoods or likelihood are equal to or less than the threshold value, the UE 100-1 does not use the input data and/or the output data having the likelihoods or likelihood as the training data.

### Other Embodiments

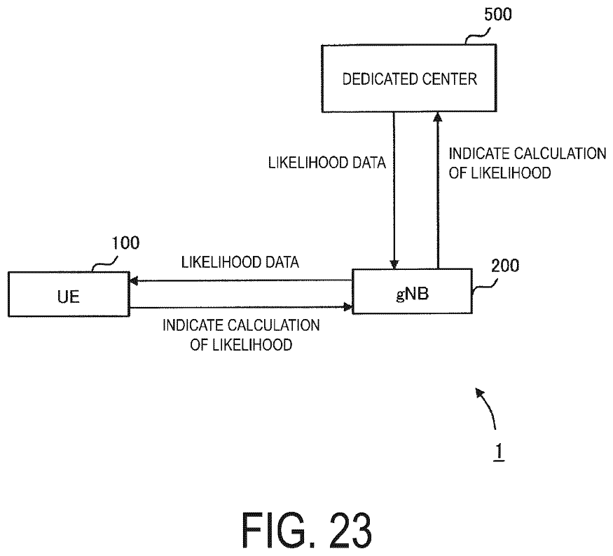

In the first embodiment described above, the example in which the data transmission entity TE and the data reception entity RE are included in the mobile communication system 1 has been described. For example, the mobile communication system 1 may include a dedicated center 500. FIG. 23 is a diagram illustrating a configuration example of the mobile communication system 1 included in the dedicated center 500. The dedicated center 500 is, for example, an apparatus that dedicatedly calculates the likelihood in calculating the likelihood in each of the likelihood filters LF-1 and LF-2. As illustrated in FIG. 23, the UE 100 transmits likelihood calculation indication to the dedicated center 500 via the gNB 200. The likelihood calculation indication may include the input data and the output data targeted for likelihood calculation. Other than the likelihood calculation indication, the input data and the output data may be transmitted. The dedicated center 500 calculates likelihoods in accordance with the likelihood calculation indication. The dedicated center 500 transmits the calculated likelihoods as likelihood data to the UE 100 via the gNB 200. Although FIG. 23 illustrates an example in which each of the likelihood filters LF-1 and LF-2 in the UE 100 calculates the likelihood, the present disclosure is also applicable to a case in which, for example, the likelihood filter LF-3 in the gNB 200 calculates the likelihood. In this case, the gNB 200 may transmit the likelihood calculation indication to the dedicated center 500 and receive the likelihood data from the dedicated center 500.

In each embodiment described above, the supervised learning has mainly been described. However, the present disclosure is not limited thereto. For example, the first embodiment to the fifth embodiment may be applied to the unsupervised learning or the reinforcement learning.

A program (information processing program) may be provided that causes a computer to execute each of the processing operations or each of the functions according to the embodiments described above. A program (for example, mobile communication program) may be provided that causes the mobile communication system 1 to execute each of the processing operations or each of the functions according to the embodiments described above. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Such a recording medium may be a memory included in the UE 100 and the gNB 200.

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. The terms “include”, “comprise”, and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure. The embodiments, operation examples, processing operations, or the like may be combined without being inconsistent.

### Supplementary Note

### Supplementary Note 1

A communication method in a mobile communication system, the communication method including the steps of:
deriving, by a data transmission entity, a trained model for a predetermined block based on a signal received from a data reception entity;
calculating, by the data transmission entity, output data corresponding to input data by using one of the predetermined block or the trained model; and
performing, by the data transmission entity, predetermined processing when a likelihood of the input data and/or a likelihood of the output data is equal to or less than a threshold value.

### Supplementary Note 2

The communication method according to Supplementary Note 1, wherein
the predetermined processing includes one of:
processing of discarding, by the data transmission entity, the input data and/or the output data;
processing of associating, by the data transmission entity, the input data and/or the output data with information indicating that the likelihood of the input data and/or the likelihood of the output data is equal to or less than the threshold value; or
processing of associating the input data and/or the output data with the likelihoods or likelihood.

### Supplementary Note 3

The communication method according to Supplementary Note 1 or 2, wherein
the data reception entity is a base station and the data transmission entity is a user equipment, and
the performing of the predetermined processing includes configuring, by the base station, the likelihoods or likelihood for the user equipment.

### Supplementary Note 4

The communication method according to any one of Supplementary Notes 1 to 3, wherein
the threshold value is a first threshold value or a second threshold value, and
the predetermined processing includes:
during the calculating of the output data by using the predetermined block, processing of switching, by the data transmission entity, to calculating the output data by using the trained model, when the likelihood of the input data and/or the likelihood of the output data is equal to or less than the first threshold value; and
during the calculating of the output data by using the trained model, processing of switching, by the data transmission entity, to calculating the output data by using the predetermined block, when the likelihood of the input data and/or the likelihood of the output data is equal to or less than the second threshold value.

### Supplementary Note 5

The communication method according to any one of Supplementary Notes 1 to 4, further including:
transmitting, by the data reception entity, a message to the data transmission entity, the message including a calculation method of the likelihoods or likelihood.

### Supplementary Note 6

The communication method according to any one of Supplementary Notes 1 to 5, further including:
transmitting, by the data reception entity, a message to the data transmission entity, the message including a minimum value of the likelihoods or likelihood,
wherein the predetermined processing includes processing of transmitting, by the data transmission entity to the data reception entity, the input data and/or the output data having the likelihood equal to or larger than the minimum value.

### Supplementary Note 7

A communication method in a mobile communication system, the communication method including the steps of:
deriving, by a data transmission entity, a trained model for a predetermined block based on a signal received from a data reception entity;
calculating, by the data transmission entity, output data corresponding to input data by using one of the predetermined block or the trained model;
transmitting, by the data transmission entity, the input data and the output data to the data reception entity; and
calculating, by the data reception entity, a likelihood of the input data and/or a likelihood of the output data.

### Supplementary Note 8

The communication method according to Supplementary Note 7, further including: discarding, by the data reception entity, the input data and/or the output data when the likelihood of the input data and/or the likelihood of the output data is equal to or less than a threshold value.

### Supplementary Note 9

The communication method according to Supplementary Note 7 or 8, further including: transmitting, by the data reception entity, a message to the data transmission entity, the message including indication information indicating switching to one of calculation of the output data by using the predetermined block or calculation of the output data by using the trained model, when the likelihood of the input data and/or the likelihood of the output data is equal to or less than a threshold value.

### Supplementary Note 10

The communication method according to any one of Supplementary Notes 7 to 9, further including:
transmitting, by the data reception entity, a message to the data transmission entity, the message including likelihood information indicating the likelihoods or likelihood.

### Supplementary Note 11

A communication method in a mobile communication system, the communication method including the steps of:
deriving, by a first user equipment, a trained model for a predetermined block based on a signal received from a base station;
calculating, by the first user equipment, output data corresponding to input data by using the predetermined block and/or the trained model;
calculating, by the first user equipment, a likelihood of the input data and/or a likelihood of the output data;
associating, by the first user equipment, the input data and/or the output data with the likelihoods or likelihood and transmitting, by the first user equipment, the input data and/or the output data and the likelihoods or likelihood to the base station;
transmitting, by the base station, the input data and/or the output data and the likelihoods or likelihood to a second user equipment; and
determining, by the second user equipment, whether to use the input data and/or the output data as training data based on the likelihoods or likelihood.

### Supplementary Note 12

The communication method according to Supplementary Note 11, further including: transmitting, by the base station, a message including association indication information to the first user equipment, the association indication information indicating associating the input data and/or the output data with the likelihoods or likelihood,
wherein the transmitting to the base station includes associating, by the first user equipment, the input data and/or the output data with the likelihoods or likelihood in accordance with the association indication information.

### Supplementary Note 13

A communication method in a user equipment configured to generate a measurement report by using a measurement reporting model, the communication method including the steps of: calculating, by a user equipment, a likelihood of input data input to a predetermined block included in a measurement reporting model and a likelihood of first output data output from the predetermined block; and
discarding, by the user equipment, the input data and/or the first output data when the likelihood of the input data and/or the likelihood of the first output data is equal to or less than a first threshold value.

### Supplementary Note 14

The communication method according to Supplementary Note 13, further including:
deriving, by the user equipment, a trained model for the predetermined block based on the input data and the first output data,
wherein the calculating includes one of calculating, by the user equipment, the first output data corresponding to the input data by using the predetermined block or calculating, by the user equipment, second output data corresponding to the input data by using the trained model, and
the discarding includes discarding, by the user equipment, the input data and/or the second output data when the likelihood of the input data and/or a likelihood of the second output data is equal to or less than a second threshold value.

### REFERENCE SIGNS

1: Mobile communication system
100 (100-1, 100-2): UE
110: Receiver
120: Transmitter
130: Controller
131: Position information generator
132: Optimum beam determiner
133: CSI generator
150: GNSS reception device
200: gNB
210: Receiver
220: Transmitter
230: Controller
231: CSI generator
A1: Data collector
A2: Model trainer
A3: Model inferrer
A4: Data processor
TE: Data transmission entity
RE: Data reception entity

1. A communication method in a mobile communication system, the communication method comprising the steps of:
deriving, by a data transmission entity, a trained model for a predetermined block based on a signal received from a data reception entity;
calculating, by the data transmission entity, output data corresponding to input data by using one of the predetermined block or the trained model; and
performing, by the data transmission entity, predetermined processing when a likelihood of the input data and/or a likelihood of the output data is equal to or less than a threshold value.

2. The communication method according to claim 1, wherein
the predetermined processing comprises one of:
processing of discarding, by the data transmission entity, the input data and/or the output data;
processing of associating, by the data transmission entity, the input data and/or the output data with information indicating that the likelihood of the input data and/or the likelihood of the output data is equal to or less than the threshold value; or
processing of associating the input data and/or the output data with the likelihoods or likelihood.

3. The communication method according to claim 1, wherein
the data reception entity is a base station and the data transmission entity is a user equipment, and
the performing of the predetermined processing comprises configuring, by the base station, the likelihoods or likelihood for the user equipment.

4. The communication method according to claim 1, wherein
the threshold value is a first threshold value or a second threshold value, and
the predetermined processing comprises:
during the calculating of the output data by using the predetermined block, processing of switching, by the data transmission entity, to calculating the output data by using the trained model, when the likelihood of the input data and/or the likelihood of the output data is equal to or less than the first threshold value; and
during the calculating of the output data by using the trained model, processing of switching, by the data transmission entity, to calculating the output data by using the predetermined block, when the likelihood of the input data and/or the likelihood of the output data is equal to or less than the second threshold value.

5. The communication method according to claim 1, further comprising:
transmitting, by the data reception entity, a message to the data transmission entity, the message comprising a calculation method of the likelihoods or likelihood.

6. The communication method according to claim 1, further comprising:
transmitting, by the data reception entity, a message to the data transmission entity, the message comprising a minimum value of the likelihoods or likelihood,
wherein the predetermined processing comprises processing of transmitting, by the data transmission entity to the data reception entity, the input data and/or the output data having the likelihood equal to or larger than the minimum value.

7. A communication method in a mobile communication system, the communication method comprising the steps of:
deriving, by a data transmission entity, a trained model for a predetermined block based on a signal received from a data reception entity;
calculating, by the data transmission entity, output data corresponding to input data by using one of the predetermined block or the trained model;
transmitting, by the data transmission entity, the input data and the output data to the data reception entity; and
calculating, by the data reception entity, a likelihood of the input data and/or a likelihood of the output data.

8. The communication method according to claim 7, further comprising:
discarding, by the data reception entity, the input data and/or the output data when the likelihood of the input data and/or the likelihood of the output data is equal to or less than a threshold value.

9. The communication method according to claim 7, further comprising:
transmitting, by the data reception entity, a message to the data transmission entity, the message comprising indication information indicating switching to one of calculation of the output data by using the predetermined block or calculation of the output data by using the trained model, when the likelihood of the input data and/or the likelihood of the output data is equal to or less than a threshold value.

10. The communication method according to claim 7, further comprising:
transmitting, by the data reception entity, a message to the data transmission entity, the message comprising likelihood information indicating the likelihoods or likelihood.

11. A communication method in a mobile communication system, the communication method comprising the steps of:
deriving, by a first user equipment, a trained model for a predetermined block based on a signal received from a base station;
calculating, by the first user equipment, output data corresponding to input data by using the predetermined block and/or the trained model;
calculating, by the first user equipment, a likelihood of the input data and/or a likelihood of the output data;
associating, by the first user equipment, the input data and/or the output data with the likelihoods or likelihood and transmitting, by the first user equipment, the input data and/or the output data and the likelihoods or likelihood to the base station;
transmitting, by the base station, the input data and/or the output data and the likelihoods or likelihood to a second user equipment; and
determining, by the second user equipment, whether to use the input data and/or the output data as training data based on the likelihoods or likelihood.

12. The communication method according to claim 11, further comprising:
transmitting, by the base station, a message comprising association indication information to the first user equipment, the association indication information indicating associating the input data and/or the output data with the likelihoods or likelihood,
wherein the transmitting to the base station comprises associating, by the first user equipment, the input data and/or the output data with the likelihoods or likelihood in accordance with the association indication information.

13. A communication method for a user equipment configured to generate a measurement report by using a measurement reporting model, the communication method comprising the steps of:
calculating, by a user equipment, a likelihood of input data input to a predetermined block comprised in a measurement reporting model and a likelihood of first output data output from the predetermined block; and
discarding, by the user equipment, the input data and/or the first output data when the likelihood of the input data and/or the likelihood of the first output data is equal to or less than a first threshold value.

14. The communication method according to claim 13, further comprising:
deriving, by the user equipment, a trained model for the predetermined block based on the input data and the first output data,
wherein the calculating comprises one of calculating, by the user equipment, the first output data corresponding to the input data by using the predetermined block or calculating, by the user equipment, second output data corresponding to the input data by using the trained model, and
the discarding comprises discarding, by the user equipment, the input data and/or the second output data when the likelihood of the input data and/or a likelihood of the second output data is equal to or less than a second threshold value.
